(19) United States
(12) Patent Application Publication
(10) Pub. No.: US 2013/0059598 A1
(43) Pub. Date: Mar. 7, 2013

(54) INTERACTIVE COMPUTER SOFTWARE PROCESSES AND APPARATUS FOR MANAGING, TRACKING, REPORTING, PROVIDING FEEDBACK AND TASKING

(71) Applicants: Haruyoshi Miyagi, Lehi, UT (US); Timothy R. Hunt, American Fork, UT (US); Per Anderson, Highland, UT (US); John Sydnor, Olympia, WA (US); David Bernstein, (US)

(72) Inventors: Haruyoshi Miyagi, Lehi, UT (US); Timothy R. Hunt, American Fork, UT (US); Per Anderson, Highland, UT (US); John Sydnor, Olympia, WA (US); David Bernstein, (US)

(73) Assignee: F-MATIC, INC., Lehi, UT (US)

(21) Appl. No.: 13/459,010

(22) Filed: Apr. 27, 2012

Related U.S. Application Data
(60) Provisional application No. 61/479,402, filed on Apr. 27, 2011.
(60) Provisional application No. 61/620,971, filed on Apr. 5, 2012.

(51) Int. Cl. H04W 4/02

(52) U.S. Cl. 455/456.1

(57) ABSTRACT

A process is provided for carrying out a task, such as enabling a customer to submit a report, feedback or other comments electronically to an online computer program, then providing a prompt on-site response to those comments. The process may be enabled by a system that includes the online computer program, which is accessible from a mobile electronic device, as well as a detectable code unique to a location from which comments are to be provided, and to which the comments may pertain. The detectable code may be scanned or otherwise sensed with the mobile electronic device, which may then communicate with the program (e.g., by way of application software on the mobile electronic device) to provide data regarding the location to the program. The program may then initiate an appropriate response to the data, or task, which may be promptly, or even immediately, carried out at the location.

### CROSS-REFERENCE TO RELATED APPLICATIONS

This application claims the benefit of priority to U.S. Provisional Patent Application No. 61/479,402 titled “Disposable Radiation Attenuating Garments,” filed Apr. 27, 2011, (the “'402 application”) and to U.S. Provisional Patent Application No. 61/620,971 titled “Process and Apparatus for Managing, Tracking, and Reporting of Employee/Customer/Patron/Guest Interaction with Company Personnel,” filed Apr. 5, 2012 (the “'971 application”) under 35 U.S.C. §119(e). The entire disclosure of each of the foregoing applications is, by this reference, hereby incorporated herein.

### TECHNICAL FIELD

This disclosure relates generally to methods, apparatuses and systems for reporting issues at facilities, and for promptly resolving the reported issues. More specifically, this disclosure relates to methods, apparatuses and systems by which a person who identifies an issue that needs to be addressed, but does not have direct responsibility for addressing that issue, may report the issue to those responsible for addressing it.

### RELATED ART

Typically, if a person notices an issue that needs to be addressed (e.g., repairs that need to be made, services or products that need to be requested, feedback that might be useful, etc.) at a particular facility, that person has to locate an individual who may be able to address the issue, or locate and call a telephone number to report the issue. These and similar efforts for report issues at a particular facility are often time consuming, and may not result in a report of the issue to a person who can address it, if any report is even made. Even when a person who spots an issue is able to report it, the issue may not be addressed promptly, if at all. Often, follow-up and tracking are inadequate, or require manual entry of information about the issue into a tracking system. This type of approach is usually so time consuming and ineffective that issues are unlikely to go unreported.

Various telephone applications and online software services are available for inspecting and reporting the status of facilities, equipment and people. Some existing internet services provide for problem reporting and generation of task work orders. Other such services carry out requests and orders for products and services. Other systems conduct surveys or track employees and their performance. Other systems provide for remote activation of various types of systems. None of the existing systems are satisfactory for a number of reasons.

As one example, a person may notice that a restroom is out of hand towels. Without an effective reporting system, this problem may go unreported and only be fixed when the custodial staff comes at their regularly scheduled time. In the meantime, customers go without service and the owner is not able to rectify the problem quickly which can reflect poorly on the company.

In this example of providing restroom cleanliness and materials, prior systems fail in several respects. The reviews of restrooms do not provide much detail other than simple ratings. They do not provide a comprehensive current condition status of restrooms for all factors, such as cleanliness, potential odors, supply levels, and plumbing problems. Restroom owners (or others responsible for the cleanliness and maintenance of restrooms) do not receive direct, actionable or real-time feedback from the reviews of their restrooms. Prior restroom evaluation systems have other failings, including they do not provide a portal to allow restroom owners to place orders with janitorial product distributors or service companies, they allow any user to change attributes of restrooms which can lead to abuse and inaccurate or unreliable information. Prior restroom evaluation systems do not allow service companies to remotely monitor those who are tasked with cleaning and maintaining restrooms. They do not provide immediate real-time information on cleanliness, supply, or plumbing issues to those who are tasked with cleaning and maintaining restrooms.

Beyond restroom maintenance, it is desirable to have a reporting and tracking system that is designed to be comprehensive with respect to many functions necessary for dealing with public facilities, equipment, machinery, hospitals, universities, hotels, restaurants, airports, remote or mobile employees and many different service-oriented companies and institutions. Typically, existing systems may be designed to handle only one problem and are not comprehensive in providing all the functions that may be needed—such as reporting problems, providing feedback, making requests, inspections, and employee performance and time tracking in a single system. Moreover, existing systems typically do not provide for mobile applications with respect to the above functions, including systems that are flexible and can be completely customizable by a company for each location, piece of equipment, facility or employee.

Systems of the types mentioned above often require the use forms that must be filled out manually and do not provide for quick responses to a number is such issues. Moreover, many of such systems have no way of GPS tracking employees or customers who report issues, in order to confirm reliability of information received. In addition, feedback is typically provided after a customer has left an establishment, so that the company cannot fix the issue while the customer is there. Further, prior systems do not include automatic escalation to management of problems, requests, negative feedback or bad inspection reports when the front line person fails to remedy the situation in a timely manner.

Additional problems with existing systems include not tracking elapsed time from issue reporting to issue completion and then providing reports to measure differences in performance across personnel, job type, departments, and locations. Prior systems often are not flexible and cannot be used across multiple industries and usage scenarios. They are often hard coded for one specific industry such as facility management or fire station inspections. In addition, prior systems may not be designed to track facilities, products and personnel within a single system. Prior systems do not allow the user interface to be customized on the fly depending on whether an employee or customer is accessing the system. Some systems do not employ automatic computer generated text messaging and emailing as a means for dispatching personnel in real time or as a means to report issues or negative feedback in real time directly to responsible parties.

### SUMMARY

A computer program process is provided for interaction between an online computer program and a mobile electronic device to carry out a task set up by the online computer program, comprising: (a) positioning a unit having a detectable code thereon at a location remote from the computer program, wherein the detectable code is indicative of the location and/or characteristics of the location; (b) sensing the detectable code using the mobile electronic device; (c) providing information from the detectable code to the online computer program using the mobile electronic device; (d) enabling the electronic device with application software to communicate with the online computer program; (e) providing additional data regarding the location to the computer program using the mobile electronic device; and (f) carrying out a task using the online computer program in response to the detectable code and the additional data.

A system for interaction with an online computer program to carry out a task set up by the online computer program, comprising: (a) a unit having a detectable code thereon at a location remote from the computer program, wherein the detectable code is indicative of the location and/or characteristics of the location; (b) a mobile electronic device capable of sensing the detectable code and providing information from the detectable code to the online computer program; and (d) application software provided to the mobile electronic device by the online computer program, to enable the mobile electronic device to provide additional data regarding the location to the computer program using the mobile electronic device; whereby the online computer program initiates a task in response to the detectable code and the additional data.

### BRIEF DESCRIPTION OF THE DRAWINGS

In the detailed description that follows, reference will be made to the following Figures, in which:

FIG. 10 is a flow diagram showing a web-based application of one embodiment according to present invention;

FIG. 11 is a sample main menu screen according to the embodiment shown in FIG. 10;

FIG. 12 is a problem reporting menu screen according to the embodiment shown in FIG. 10;

FIG. 13 is a request menu screen according to the embodiment shown in FIG. 10;

FIG. 14 is a feedback menu screen according to the embodiment shown in FIG. 10;

FIG. 15 is a feedback employee reporting and inspection menu screen according to the embodiment shown in FIG. 10;

FIG. 16 is another request menu screen according to the embodiment shown in FIG. 10;

FIG. 20 is a flow diagram showing an embodiment of an account setup process for a web-based application;

FIG. 21 is menu screen showing a part of the embodiment of setup process shown in FIG. 20;

FIG. 22 is menu screen showing another part of the embodiment of setup process shown in FIG. 20;

FIG. 23 is menu screen showing another part of the embodiment of setup process shown in FIG. 20;

FIG. 24 is menu screen showing another part of the embodiment of setup process shown in FIG. 20;

FIG. 30 is a flow diagram showing an embodiment of a process by which the manager of a facility, or a company, may set up a web-based application that incorporates teachings of this disclosure;

FIG. 31 is menu screen showing a part of the embodiment of setup process shown in FIG. 30;

FIG. 32 is menu screen showing another part of the embodiment of setup process shown in FIG. 30;

FIG. 33 is menu screen showing another part of the embodiment of setup process shown in FIG. 30;

FIG. 40 is a flow diagram showing an embodiment of a process for setting up problem issues for a web-based application;

FIG. 41 is an embodiment of menu screen for use in executing the embodiment of setup process shown in FIG. 40;

FIG. 50 is a flow diagram showing an embodiment of a process for setting up request issues for a web-based application;

FIG. 51 is an embodiment of a menu screen for use in executing the request issues setup process shown in FIG. 50;

FIG. 60 is a flow diagram showing a feedback issues setup process for a web-based application of one embodiment according to present invention;

FIG. 61 is menu screen showing the feedback issues setup process according to the embodiment shown in FIG. 60;

FIG. 70 is a flow diagram showing a template setup process for a web-based application of one embodiment according to present invention;

FIG. 71 is menu screen showing the template setup process according to the embodiment shown in FIG. 70;

FIG. 80 is a flow diagram showing a QR code setup process for a web-based application of one embodiment according to present invention;

FIG. 90 is a flow diagram showing a reports setup process for a web-based application of one embodiment according to present invention;

FIG. 91 is menu screen showing the reports setup process according to the embodiment shown in FIG. 90;

FIG. 92 is menu screen showing the reports builder setup process according to the embodiment shown in FIG. 90;

FIG. 100 is a flow diagram showing a dashboard setup process for a web-based application of one embodiment according to present invention;

FIG. 101 is menu screen showing the dashboard setup and response average process according to the embodiment shown in FIG. 100;

FIG. 110 is a flow diagram showing a QR code setup process to activate devices for a web-based application of one embodiment according to present invention;

FIG. 121 is a flow diagram for a mobile phone-based application of the present invention of one embodiment of the present invention in a restroom setting;

FIG. 122 is a menu screen of the mobile phone showing functions according to the embodiment shown in FIG. 121;

FIG. 123 is a scan screen of the mobile phone showing functions according to the embodiment shown in FIG. 121;

FIG. 124 is a summary review screen of the mobile phone showing functions according to the embodiment shown in FIG. 121;

FIG. 125 is another review screen of the mobile phone showing functions according to the embodiment shown in FIG. 121;

FIG. 126 is a current condition screen of the mobile phone showing functions according to the embodiment shown in FIG. 121;

FIG. 127 is a cleanliness report screen of the mobile phone showing functions according to the embodiment shown in FIG. 121;

FIG. 128 is a location list screen of the mobile phone showing functions according to the embodiment shown in FIG. 121;

FIG. 129 is a map screen of the mobile phone showing functions according to the embodiment shown in FIG. 121;

FIG. 130 is a flow diagram for a mobile phone-based application of the present invention showing interaction with an online data base according to the embodiment shown in FIG. 121;

FIG. 131 is a restroom list computer screen according to the embodiment shown in FIG. 130; and

FIG. 132 is a supplier list computer screen according to the embodiment shown in FIG. 130.

### DETAILED DESCRIPTION

### Overview.

The following description provides various embodiments, methods, apparatus, and or systems of the present invention. As used herein, the terms “web,” “online” and “internet” are synonymous and mean an Internet or intranet network. The term “he” means “he,” or “she” and “his” means “his” or “her.” The term “mobile phone” means any type of mobile electronic device. The term “detectable code” means an electronically detectable code, such as a bar code or matrix code, including without limitation a quick response (QR) code that can be sensed by an electronic device, such as a mobile phone.

The present invention, also referred to herein as the “Quick Request” system or “present system,” is a customer interaction system that uses mobile smartphones scanning quick response (QR) bar or matrix codes to communicate problems to a company, make requests, provide feedback and allow the company's employees to report their work and have others inspect that work without paperwork. Using the present invention, a person may scan a QR code located at a door, wall or other convenient location in order to report an issue. The present system routes the electronic notice to the right person immediately. The QR code represents the location of the problem, and the type of problems that can be at that location are customized by the administrator on the web administrative site, which builds a custom web app for each QR code. Employees check in to areas by scanning other QR codes for their department to receive messages concerning those areas.

### Web-Based Program and Mobile Phone-Based Program.

One type of embodiment of the present invention involves the use of a web-based application program that provides mobile phone access to an online program to carry out the process of the invention. In this system, the application software remains on the server of the online computer program and is made available to a mobile phone as needed through a web browser. Most of the following description involves various uses and applications of web-based program embodiments.

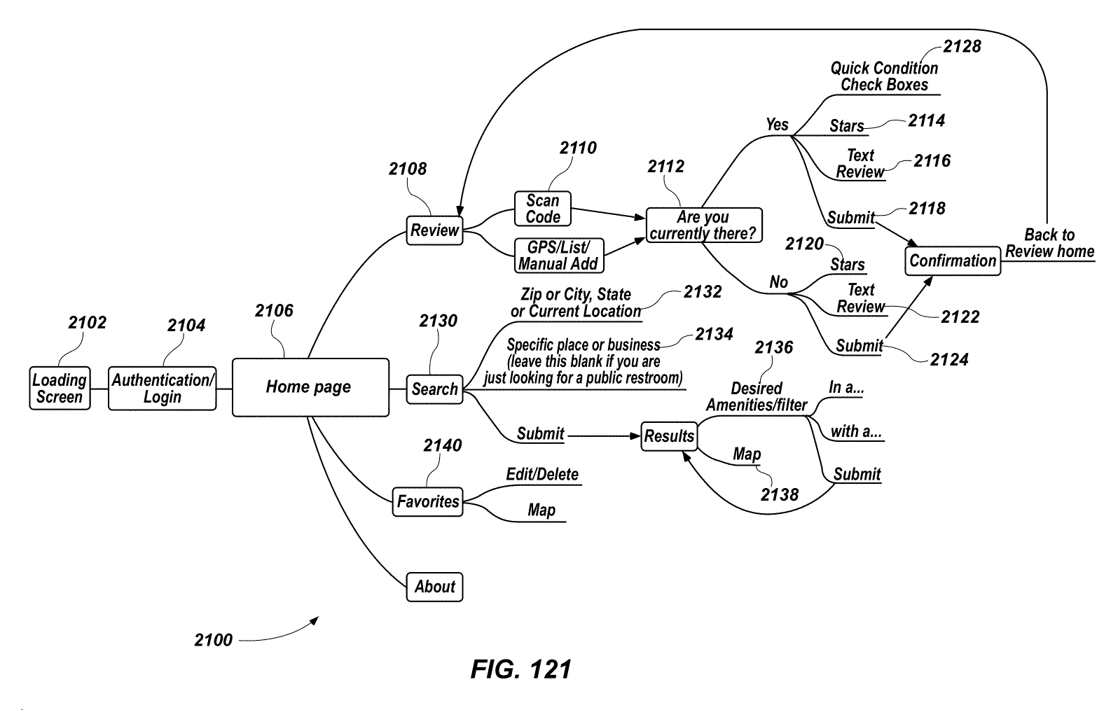

Another type of embodiment of the present invention involves the use of a mobile phone-based application program, in which the system operation is very similar to the web-based program, except that in the mobile phone-based program embodiment, the program is downloaded in a format to fit the mobile phone being used, such as iOS or Android formats. One example of the mobile phone-based program embodiment is the use of the same in a restroom setting, beginning with the description related to FIG. 121. It should be understood that the mobile phone-based program type of embodiment may be applied in all of the applications and environments discussed below with respect to the web-based program embodiment.

The following descriptions of the systems of the present invention apply to both web-based application programs and mobile phone-based application programs. The following systems may use smart phone web-based applications, administrative reporting and tracking applications software, multiple databases, and/or servers. The following systems may also utilize data transfer protocols that are used in the mobile phone market, as well as WAN, LAN and Wi-Fi networks.

In one embodiment, a unique QR code is used as the starting point for any customer interaction. Each QR code is created by appending an encrypted identification alpha, character, numeric string to a main secure website. A customer, guest, patron or employee can use his smartphone and any QR code reader or scanner to scan the QR code that is typically on a plaque on the wall, on a receipt, a sticker on equipment, or on a product, although it is not limited to be displayed with these mediums only. He scans the QR code the system and the mobile device reads the unique QR code address and on the fly dynamically builds a customer mobile application within a web browser or the QR Scan application's interface. The user interface displayed on the phone is determined by the method and content that was selected and generated by the system administrator using the web-based administrative site. Each location or QR code may have a unique interface, because the system does not require all information to be used by all QR codes universally.

In one embodiment, when a user scans a QR code for the first time it asks him to enter his first name, last name, email address, and a password. This information may be used to create a unique hash code token on the phone for that mobile user. When an issue is sent by the mobile user using the present system, his token is also sent and the backend server decrypts the token to determine the name of the person who sent the information. It then uses this information when it sends the computer-generated text to the employee to handle the issue.

The present system enables patrons, customers or guests of an establishment, building, facility, school, airport, hotel, public restroom, theater, arena, event center, convention center, etc. to be able to report a problem, make a request for a product or service, make a request for information or request to see a video, as well as provide feedback in the form of surveys, polls and questionnaires.

Moreover, the present system enables employees of a company that deals with facilities, products, or services of the company to report a problem, make a request for a product or service, make a request for information and or a video, provide feedback in the form of surveys, polls, and questionnaires, enter data concerning the status or readings of any equipment or machinery, as well as be able to check in and checkout of locations for specific job purposes and complete reports on work performed and or provide an inspection of previous work performed.

In addition, the present system enables company owners, facility managers, custodial personnel, employees, staff members, and others within the company to receive communications from customers, patrons, guests and employees. These communications may be concerned with problems, requests, feedback, and reports in real time as actionable information that the company owners can use to improve performance, maintain facilities, maintain levels of service, keep facilities clean, keep facilities safe, and ensure proper levels of consumables are properly stocked in real time and have all remedies of any issues tracked by location, worker, date, time, type of issues and or service and elapsed time from first report to issue completion.
a. The present system provides that everything within a web-based mobile application is customizable by the company that licenses the service to include any or all of the following items or functions: labels of templates, problems, requests, feedback and reports, the logo displayed within the mobile application as well as on the web based administrative application,
b. the active or inactive state of any problem, requests, feedback, template, employee, area, department or QR code,
c. the state of any problem, requests, feedback, report, template, or QR code as being either internal for employees only, a specific department of employees only or for everyone,
d. the state of any toggle type as being either maintained as changed or reset back to the default option on send,
e. categories or templates of problems, requests, feedback, and reports,
f. toggle response types to include toggles, links, checklists, numeric requests, complex requests, ratings, and free form text boxes,
g. the labels on any buttons, or toggle types,
h. the messages sent to the user in response to using the system,
i. numeric value wheels,
j. complex requests configurations that include pictures, descriptions, prices, currency symbols, request times and request quantities,
k. free form text boxes for custom input,
l. URL links for linking to videos, information and websites,
m. data readout logs that can provide the user with feedback concerning the status of equipment, and machinery.
n. the ability to determine if a value or state change is to be automatically dispatched, texted, or emailed to an employee or allowed to be recorded only,
o. the ability to generate automated text messaging and or emails to employees concerning problems, requests, feedback, or reports that need to be handled in a timely manner and closed,
p. the ability to use toggle types, i.e. customizable yes/no toggles where the terms for yes and no are customizable by the company, numeric wheels, 5 star rating toggles,
q. the ability to handle complex requests with images descriptions and prices, URL links, checklists, and free form textboxes as well as any future toggle types that may be added the system allows users to quickly report issues,
r. the ability to make requests, provide feedback and report on work performed without extensive text and data input, and
s. The use of a toggle, star, button, checklist box, etc. while pushing “send” which enables data to be recorded including the issue, the person who submitted it, the location, product or person that is related to the issue as well as the date and time without lengthy data input.

The present system enables any QR code at any location to be locked by GPS location with a range tolerance that would require an individual, be they employee or customer to be on site to interact with the system. The system also enables for the capture of any individuals GPS locational data to be recorded with the report of an issue and said information can be displayed on a map within the dashboard, provided the end user authorizes such tracking. The information is filterable to any department, area, customer, employee, or issue, regardless of whether it is an open issue or closed issue. Because the customer, guest, or patron scans the QR code on site of the business and is able to and encouraged to provide feedback immediately the system can alert management or personnel of the business of any issue that receives a negative response from the customer, guest or patron while the patron is still on premises. The system also provides the company personnel with the negative response information as well as the name of the person who submitted the information.

Moreover, the present system enables the system administrator(s) to set appropriate response times, which is the amount of time in minutes, hours or days that a person who receives a request to fix a problem, provide a service or product to be able to reasonable fix the problem or fulfill the request and close the issue. If the issue is not closed within that allotted time set by the administrator the system automatically escalates the issue to the manager of that individual. If that manager does not respond within the same time frame and or close the issue it is escalated to that manager's manager and so on until the issues is resolved.

For every issue or negative feedback or employee report or inspection that fails, the system records all information to include the QR code scanned, GPS data if applicable, the name of the individual who reported the issue, the date and time of the report, whether or not it was reported by an employee or customer, what issue was reported, the state or toggle information from the person who reported it, who received the text or email concerning the issue to remedy the situation, whether or not the issue was escalated to the next level and if it was at what date and time it was escalated and to whom it was escalated, as well as the date and time it was closed and by whom it was closed.

The present system is enabled to handle multiple industries and is flexible to handle any type of facility, product or service, for any specific task, or for any specific type of personnel. The following industries could use this systems, although this is not an complete list: airlines, airports, arenas, building maintenance, business services such as insurance companies, car dealerships, car rental companies, casinos, clinics, colleges, construction, convention centers, cruise ships, custodial services, event centers, facilities management, factories, fast food, fine dining, franchises, governments, government buildings, grocery stores, hospitals, hospitality, hotels, janitorial supply, movie theaters, nursing homes, office buildings, product manufacturers, property management, quick service restaurants, realty, rental properties, resorts, schools, security, stadiums, taxis, textile rentals, theme parks, universities, vending machines, etc.

Once a company is setup with department and areas of QR codes to divide up the departments, then employees can scan a QR code to check in to a specific area within a department to become the first responder to any problem, to request or provide negative feedback that may be submitted by anyone. The system checks out the previous person at the same time ensuring that at any one time if an issue is being sent it will be received by an individual.

The present system also enables custom-built Application Protocol Interfaces to be appended to the system to allow for the transference of data to databases of applications whether they are web based, server based or application based on a specific computer.

The present system also may enable an individual to set up his phone to remotely control a mechanism or system. The present system may be used to operate any type of device that is electronic in nature. For example, using the present system, a user may unlock a device such as a hotel room door or any other type of door with an electronic lock and an available data network. For the door unlocking system to work a hotel, for example, it may be outfitted with a Wi-Fi chip in the door lock and a specific double encryption code for unlocking the door. The door is still unlocked electronically by the same means that a key card unlocks the door, but now the message to unlock the door may come via a Wi-Fi network instead of from the keycard magnetic strip.

In the above hotel room example, when a person makes a reservation online he may choose to check into his room using the present system and bypass the front desk at check in. If he chooses this option, the reservation software computer screen generates a unique QR code for the reservation. When the person scans the QR code on the screen it passes to the reservation system the person's unique token that was generated when he first signed up using quick request on his phone. Multiple phones could scan the same QR code and all those phones would be valid for unlocking the door. Then when the guest arrives at the hotel he scans a QR code to receive a selection of rooms available and he selects his room which checks him in using his phone. Once the room has been selected he may then go straight to his room bypassing the front desk.

When the guest arrives at his room, he scans the QR code on the door lock and this sends a message back to the Quick Request Server with the user's encrypted hash token and the unique door lock QR code that was scanned. The present invention then passes this information to the hotel server through an API, which verifies that the user token matches the reservation information for the room and that the date and time of allowable check in and room usage matches with the reservation. If this information is confirmed by the system then the door is unlocked electronically by sending an encrypted code to the door lock over the Wi-Fi network using an https-secure connection, which is also encrypted.

### Mobile Phone Web-Based Applications

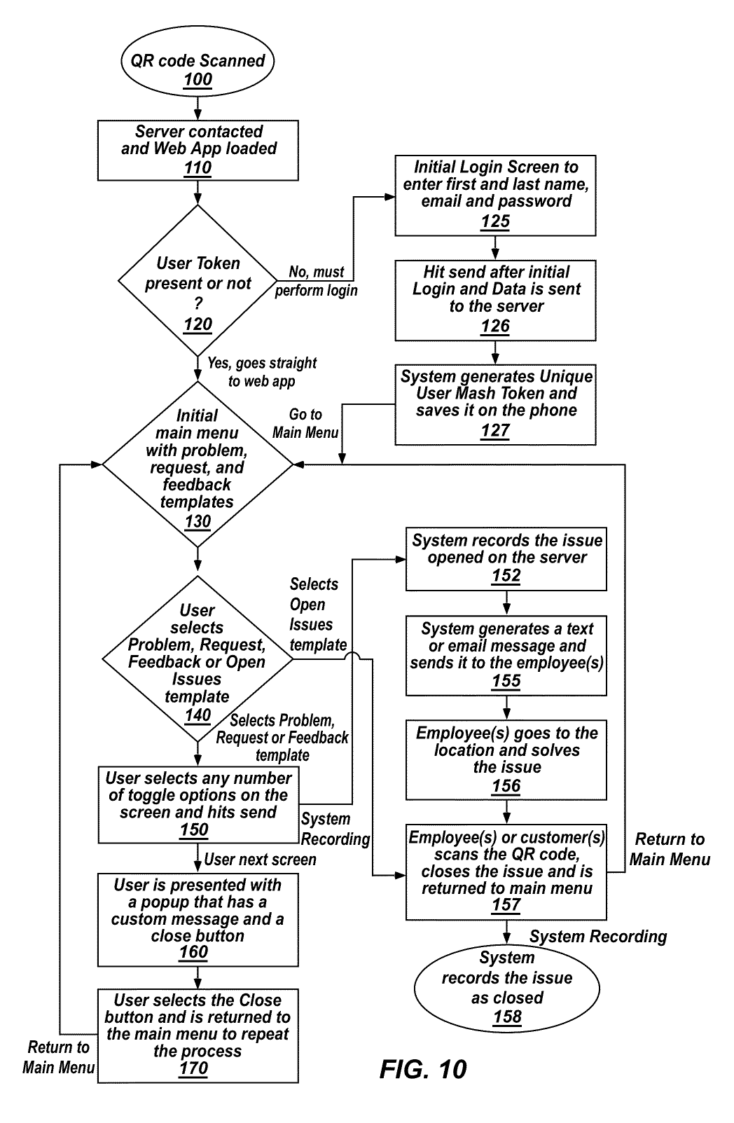

As depicted in FIG. 10, a flow chart shows an embodiment of a process 100 that incorporates teachings of the present invention. In a specific embodiment, the process 100 may be effected as a mobile phone user scans a Quick Request QR code with any smartphone or device that has a mobile QR code reader or scanner. This action executes a server call 110 in the custom mobile web application for that specific QR code as an embodiment of the present invention.

The system then checks at 120 to see if there is a User Token present on the mobile device or not. If the mobile user is scanning a Quick Request QR code for the first time and they do not have a token on their phone the screen loads at 125 an Initial Login Screen to enter their First Name, Last Name, Email, and a Password with a confirmation of the password. The user then hits Send at 126 and the data is sent to the server. At 127 the system creates a unique hash token that is then saved on the mobile user's phone. Once this token is on the phone if he scans a Quick Request QR code in the future he is taken directly to the initial Web Screen at 130 with the main menu options. This happens regardless of what QR code he scans. However, if he uses a different scanner or he changes his phone it may require him to login again.

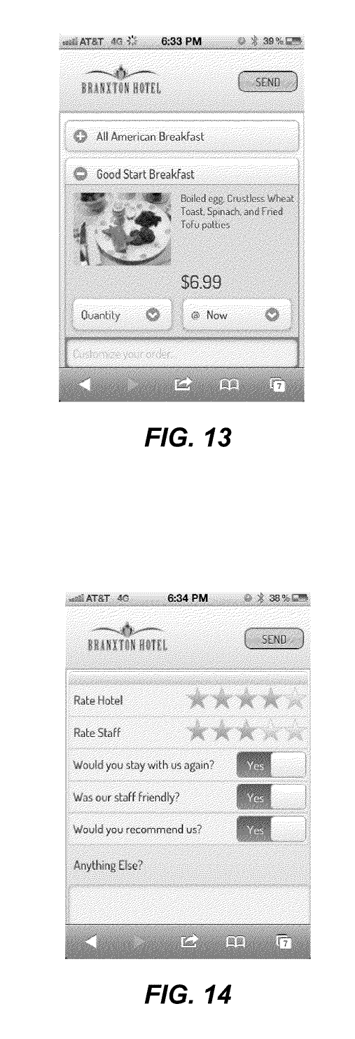

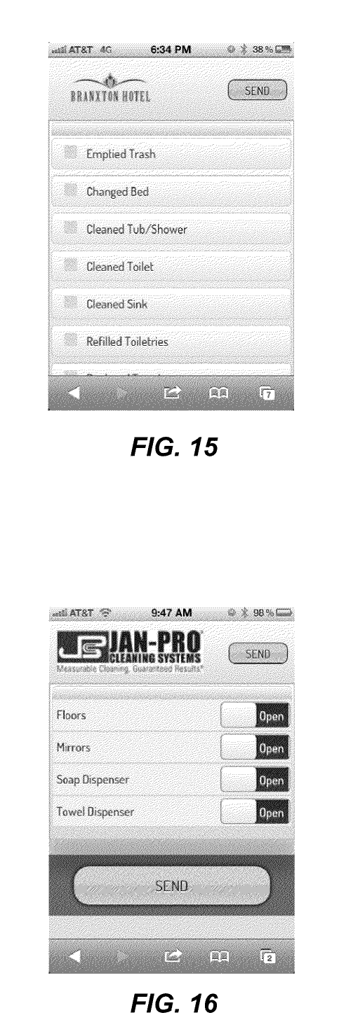

Once the mobile user is at the main menu screen he sees the company's logo that is currently paying for the system at the top and he is presented with one to many different buttons on the screen with a label on each and a right pointing arrow on the right side. The number of options presented depends on how many templates were created by the system administrator for display on the phone. There are four types of menu buttons that can be displayed on the phone. They are problem templates (see sample in FIG. 12), request templates (see sample in FIG. 13), and feedback templates (see samples in FIGS. 14 and 15) and a My Requests/Pending Request template (see sample in FIG. 16) that includes any open issues. Feedback templates can include surveys or polls, inspection reports, and employee reports. When these issues are created on the administrative website they are loaded on the phone in alphabetical order for each type of template. All problem templates will be on the top. All request templates will be in the middle and all feedback templates will be at the bottom.

The mobile user can select at 140 one of the main menu items and the screen slides over to reveal the individual issues on the next screen. There can be from one or more issues depending on what the system administrator set up. The mobile user can then select at 150 any toggle issue and hit send. The mobile user is presented with a friendly message at 160 about the issue and a close button. At the same time the system at 152 opens a record on the server and records the following about the issue. It records the location name of the QR code that was scanned, the name of the person who sent the message, whether or not he is an employee or customer, the date and time the send button was selected, the issue(s) that were selected, the status and toggle information about the selected item, the template name of the issue that was sent, and who was sent the text message concerning the issue to resolve it. The system then sends at 155 a computer generated text message or email to the employee that is currently checked in to that area and in the responsible department(s) for solving the issue. The employee at 156 goes to the location, solves the issue and at 157 scans the QR code to close the issue. He can close the issue because a new sub menu called Pending Requests (see FIG. 16) was created on the bottom of the 130 main screen that allows him to select the option at 140, and at 157 toggle the option closed which at 158 records the issue as closed. The system then records the issue as closed and takes the employee back to the main menu at 130.

Once an issue has been sent, a My Requests or Pending Requests menu item appears at the bottom of the main menu screen at 130 and shows the mobile user or employee what issues are currently open. It includes an open/close toggle for each issue and at 157 the customer or the employee can close these issues by selecting the toggle to close and hitting Send. The issue is then closed and at 158 the system records it as closed on the server and returns the user to the main menu at 130. When the system at 158 closes the issue it records the name of the person who closed it, the date and time closed as well as calculating the elapsed time.

Feedback items are unique in that they can be recorded in the system at 152 but may not be required to be reported by text message or email to the employee at 155. The system administrator decides for each issue what level of response will mandate an employee be notified, if at all. These issues will only be put on the My Requests/Pending Requests sub menu and require a closure if the administrator has chosen to have them escalated to an employee. If the administrator has not, then the issues do not need to be closed and are only recorded for reporting in dashboards and reports.

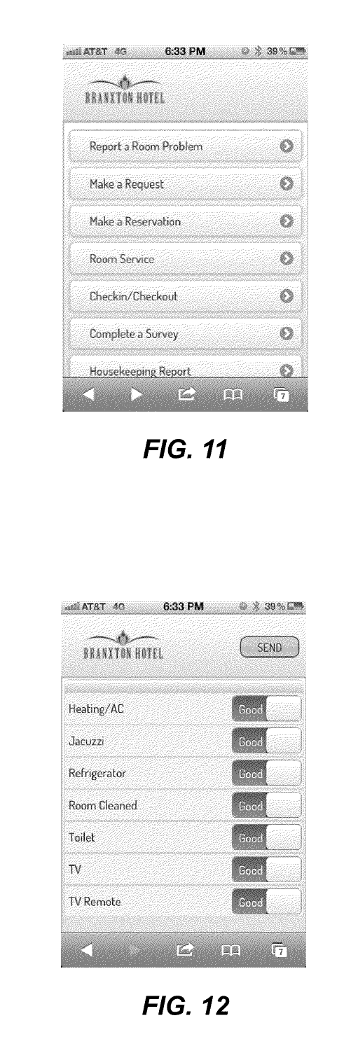

The process can be repeated indefinitely and all recording of the issues reported and actions taken to close each issue are recorded by the system. However, it is important to note that because the system administrator licensed to use Quick Request can customize everything on the mobile application that each customer will have different screen layouts and content. FIGS. 11-16 are only a few of an infinite number of possibilities.

### Administrative Process for Setting Up Web-Based Applications, Database Functions and Recording

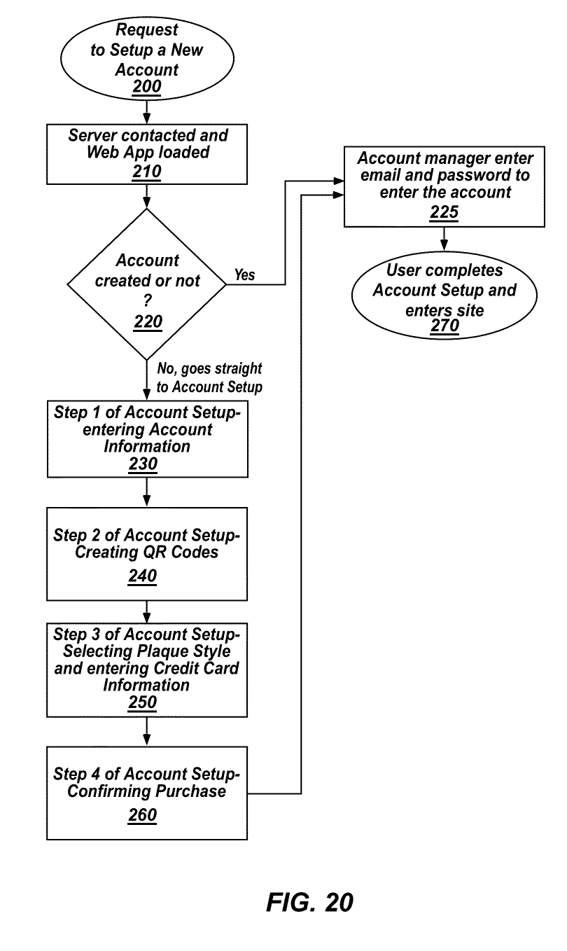

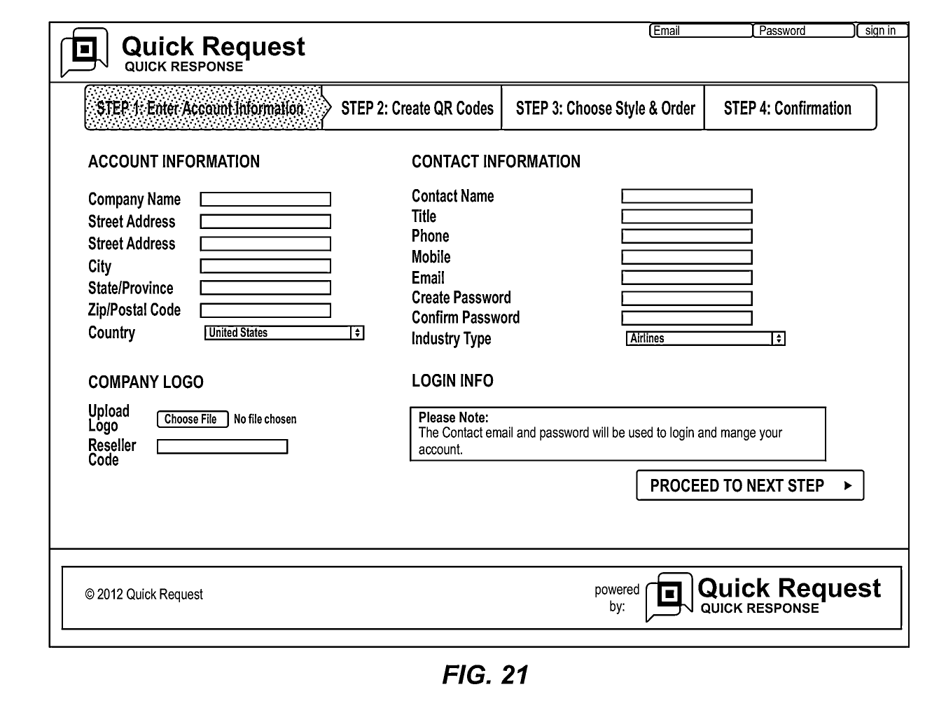

Referring to FIG. 20, a flow diagram is shown depicting a process 200 of setting up an account to use the Quick Request administrative web application and database. The administrator first selects Account Setup at 200 to begin the process of creating his account. The server is contacted at 210 and it gives him two options at 220 to either enter at 225 his email and password to enter his account or begin Step 1 of Account Creation at 230 (see FIG. 21) where he enters the basic account data, such as Name of company street address, city, zip, country, company logo, contact name, title, phone, mobile phone, email, password, confirm password and select their industry type. Once he has completed the basic account information at 230 he selects the button Proceed to Next Step.

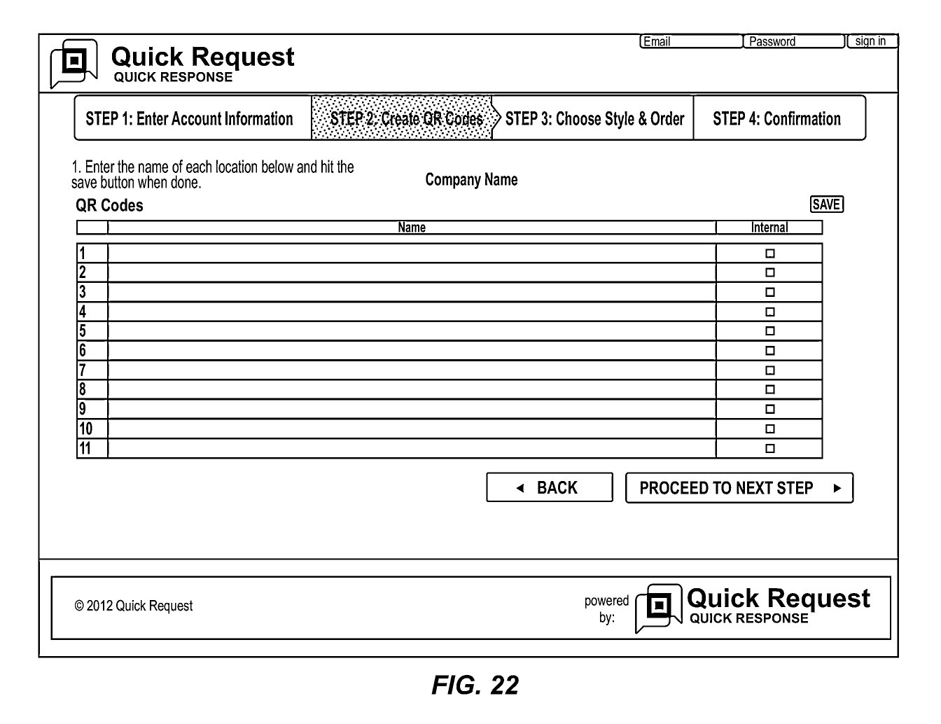

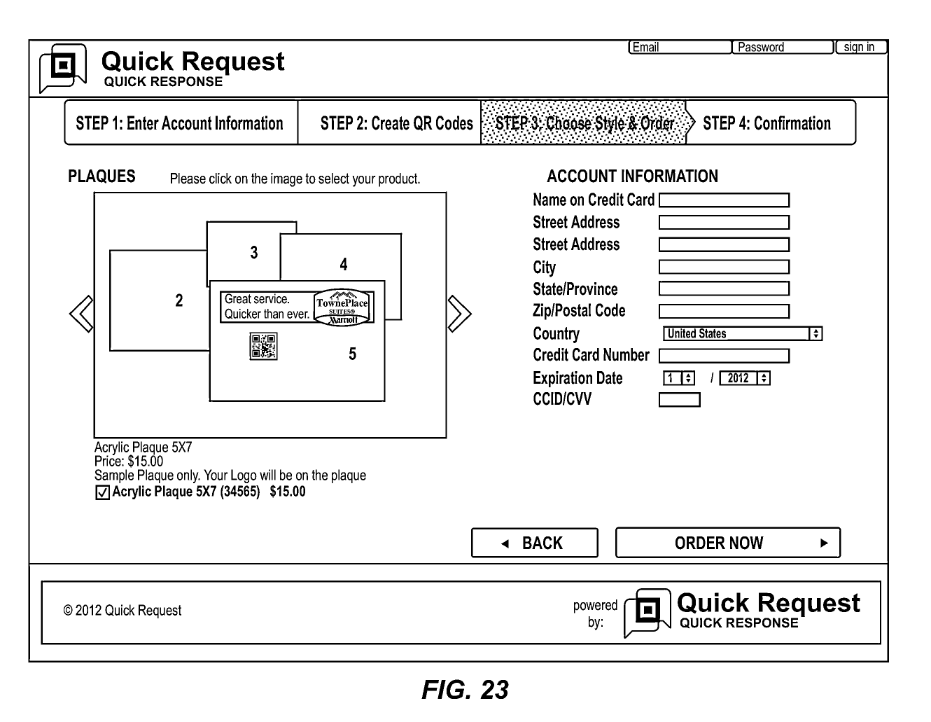

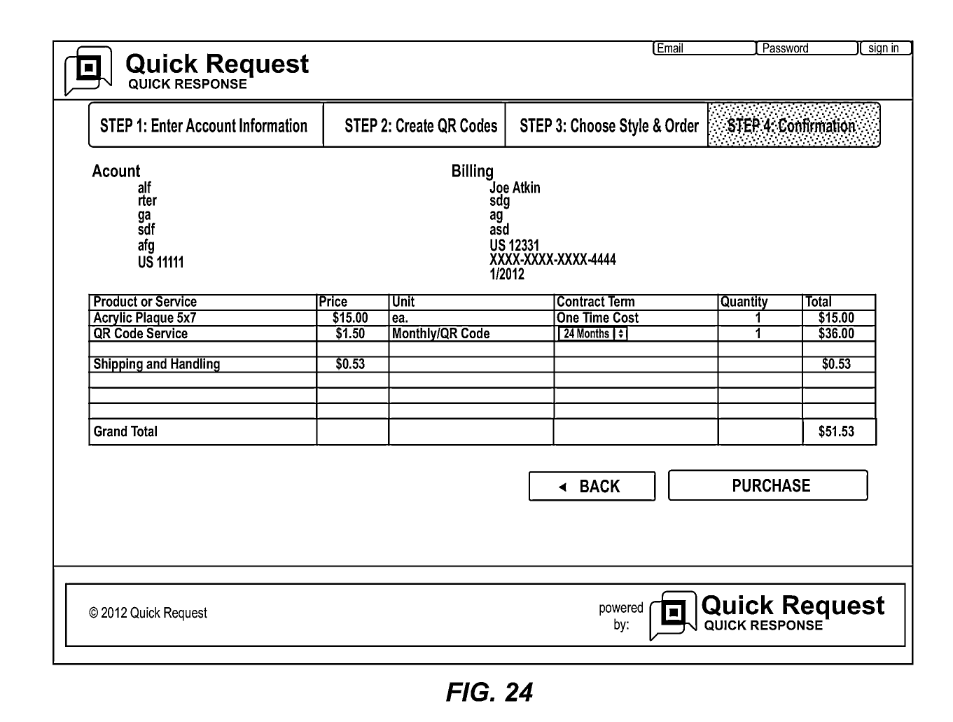

At Step 2 of the account setup shown in 240 (see FIG. 22) the administrator enters the name of each QR code location. He has the option to make them internal if he wants them to be for employees only, but can leave them as open to both the public and employees. He then hits either Proceed to Next Step or Back if he wishes to change any initial account setup information. When he hits Proceed to Next Step he is taken to Step 3 of Account Setup shown at 250 (see FIG. 23) where he chooses his style of plaque and enters his credit card information. He then hits Order Now and is taken to Step 4 shown at 260 Confirmation (see FIG. 24) of his order information. He can then hit Purchase and complete the account setup. He is then taken back to a screen where he can enter at 225 his email and password and enter the Quick Request Administrative Web Application.

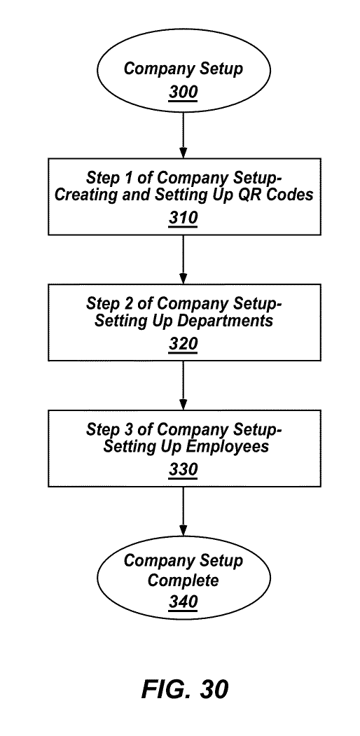

Referring to FIG. 30, a flow diagram is shown depicting a process 300 of setting up a company to use Quick Request in the administrative web application and database. The administrator selects setup and is taken to 310 Step 1 of Company setup. In Account Setup at 240 (see FIG. 20) he created his QR Code label names and these are populated in 310 when he enters. He can also create at step 310 additional QR codes, change the names of the QR codes, or make the QR codes inactive if they are no longer needed or set the parameters for the QR codes. At the top of step 310 at Company Setup Step 1, the administrator is able to customize the Initial Web Screen at 130 on the mobile device for Open Issues. The Customer Menu Label is what the customer will see on his mobile device at the bottom of his Initial Web Screen at 130. This is often labeled My Requests.

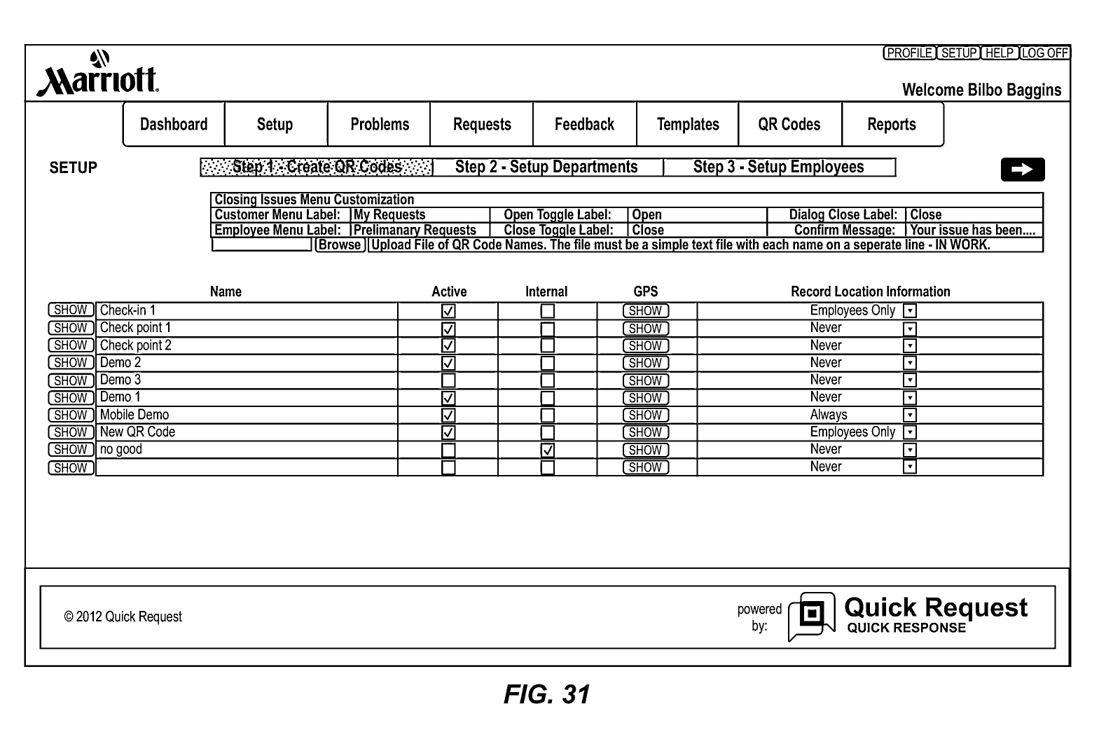

Referring to FIG. 31, the Employee Menu label is what an employee will see as the bottom item on the Initial Web Screen at 130. This is often labeled Pending Requests. For each open issue there will be a toggle on the 140 submenu screen and the labels Open and Close are the states of those issues that the user can toggle at step 150 in FIG. 10 to change the state and hit send. The Dialog Close Label is the label for the button that the administrator will hit at 160 to close the confirmation message after he has hit send. The Confirmation message is the message he will be presented with after he hits send. The Browse to upload is a function that allows the user to upload a list of QR code names to the system and have them populated in the table at the bottom half of the Create QR Codes screen at 310.

For each QR Code there is a set of parameters that the administrator can set. The first column has a Show button that will display the unique QR code for that line item below the word Setup on the 310 Step 1—Create QR Codes screen. This allows the administrator to scan the QR code and validate any settings or setup he has created for that QR code. The Name of the QR code is in the next column and can be edited by clicking on the name and typing a new name or editing the existing name. The next column is the Active checkbox column. If unchecked then the QR code becomes inactive and will no longer be displayed on the mobile interface 140, if scanned. The next column is the Internal column. This can be set if the administrator wishes to have the QR code be used only by employees. If checked the system will only display on 130 and or 140 main menu for employees. The next column is a Show button for GPS locational information. If the administrator hits the Show button the screen expands below the QR code line and the user is allowed to enter the latitude, longitude, elevation, and a tolerance range. If these items are left blank or at 0 then anyone can scan the QR code from any location.

If the GPS parameters are set, then only individuals that have GPS coordinates on their smart phone are within the tolerance range of the GPS coordinates entered can use the QR code. This option, when needed, is used to ensure that the individual that is reporting a problem, making a request or providing feedback is actually within the geo locational boundaries of the establishment. The last column is used for recording geo locational data when a mobile end user scans a QR code and hits send. The three options are Never, Employees Only, and Always. If marked as Never the information is not collected. If marked as Employees Only, then when an employee in the system scans a QR code and hits send the system will first ask for permission to use their GPS data and if he hits yes it will capture the mobile devices GPS data and include it with the issue. This information is then presented on a map on the dashboard. If it is marked as Always, then both employees and customers will be asked to confirm using GPS locational information and the data will be submitted to the system with each issue sent.

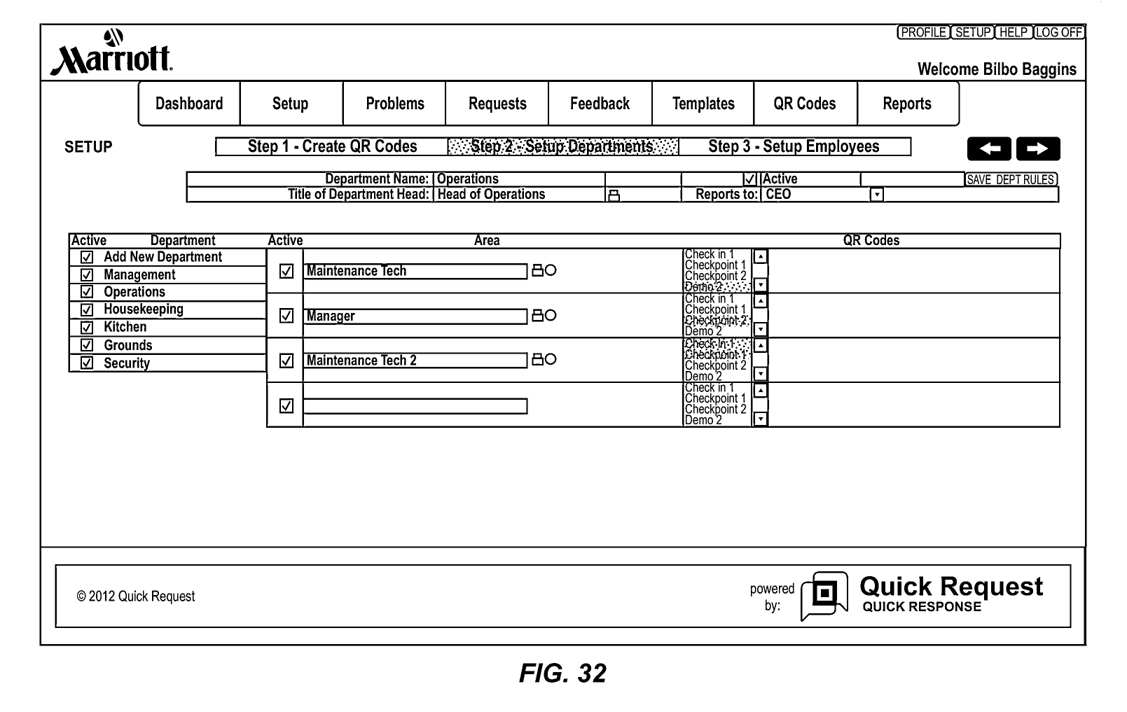

Referring to FIG. 30 again, Step 2 shown at 320 of the Company Setup (see FIG. 32) involves setting up departments, sub areas of departments, roles for heads of departments and hierarchy of what department heads are over what other department heads. The form is completed by entering the name of the department, marking the department as active department or not, entering the title of the head of the department and then selecting the title of the department head that supervises this department head title position. The administrator can then divide department up into different areas by naming each area and then using the multi-select list on the right to select what QR codes are part of that area. The rule is that each QR code must be assigned to one and only one area in each department. The system does an error check for this step when they hit the arrow button to proceed. If any QR code is not assigned to a single area or if any QR code is assigned to two areas the system will display an error message concerning the error and QR code(s) out of compliance. The print icon to the right of any area and to the right of the title of the department head is used to print a unique QR code for the area or department head so an employee can scan into the area when he is asked to be responsible for any issues sent by text or email from those QR codes for that department. Once he scans this QR code the system tells him that he is checked into the role, and he becomes the first responder to any problem, request, or negative feedback that is assigned to that department.

The system is designed such that problems, requests or feedback are assigned to a responsible department when they are created. See FIGS. 30, 40 and 50. When the user toggles an issue, for example reporting that a room is dirty and if this problem were assigned to the custodial department then the person who is checked into the area where this QR code is included as a part of that area will receive a text message or email concerning the issue, what QR code was scanned and who reported the problem. Administrators can return to Step 2 of Company setup at 320 at any time to add new departments, modify or create new areas within the department and or modify the QR codes, which are in what areas for reporting purposes. When the administrator has completed the department setup he hits Save Dept/Areas. Once all departments are set up, he can proceed to Step 3 of the Company Setup shown at 330.

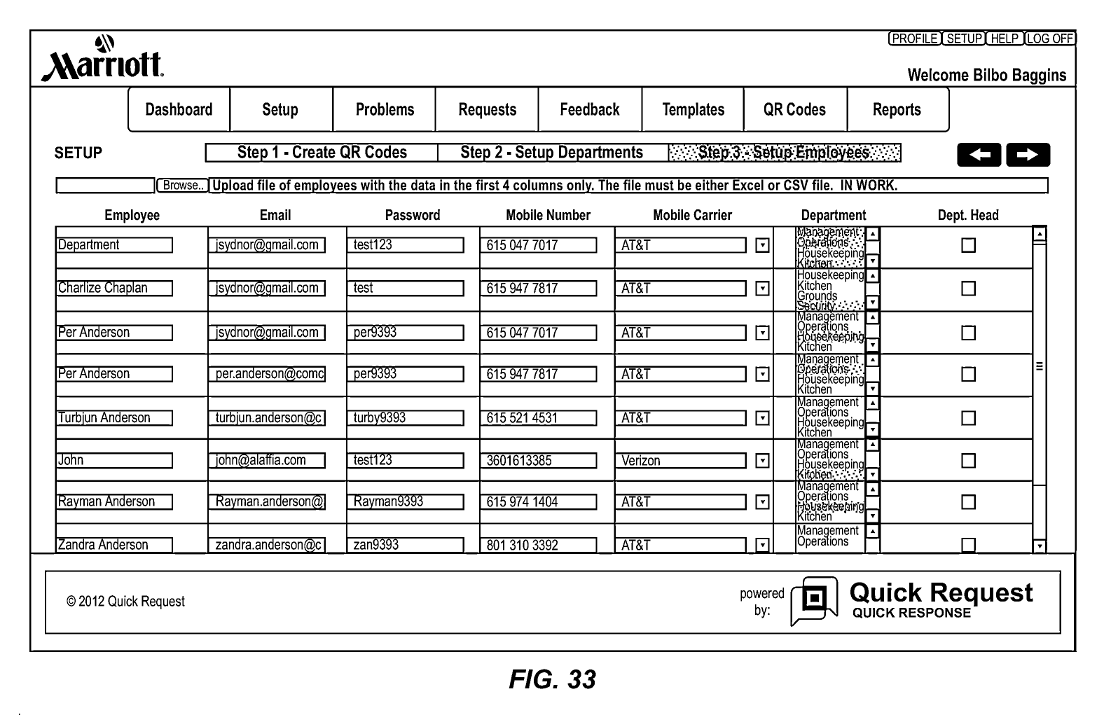

At Step 3 of the Company setup shown at 330 (see FIG. 33) the administrator adds the employees to the system. He can either enter the data in the table directly or upload a CSV file with data for the first 4 columns of the table only. These columns include Employee Name, Email, Password, and Mobile Phone number. The Employee Name, Email and Password must match the credentials the employee used or will use the first time he enters his Login information on the mobile device at 125. This will create a token on the backend that matches his token on the phone so the system can recognize the mobile user as an employee. If a mobile user is not an Employee in the database and he scans a QR code and he is automatically entered into the database as a customer of the company.

In order for the system to send free text messages to the users the administrator must select from a drop down list the carrier that the mobile phone user has for that mobile phone number Likewise the administrator must select which departments the employee is allowed to scan into to check in as a first responder to any issue in that those departments for any areas of those departments. He can be allowed to check in to areas in multiple departments if the administrator selects multiple departments for the employee. If the employee tries to scan in to an area that the administrator has not authorized him to scan into, he will receive an error message on his mobile device telling him that he is not authorized for this area or role and to contact the account administrator. The last column is a checkbox denoting whether or not the employee can check in to the departments selected for that employee as the department head. If checked then he is authorized to check in to any of the department head roles for the departments for which he is authorized. When the administrator is done setting up all the employees he hits the right arrow to exit the company setup wizard and return to the administrative web application.

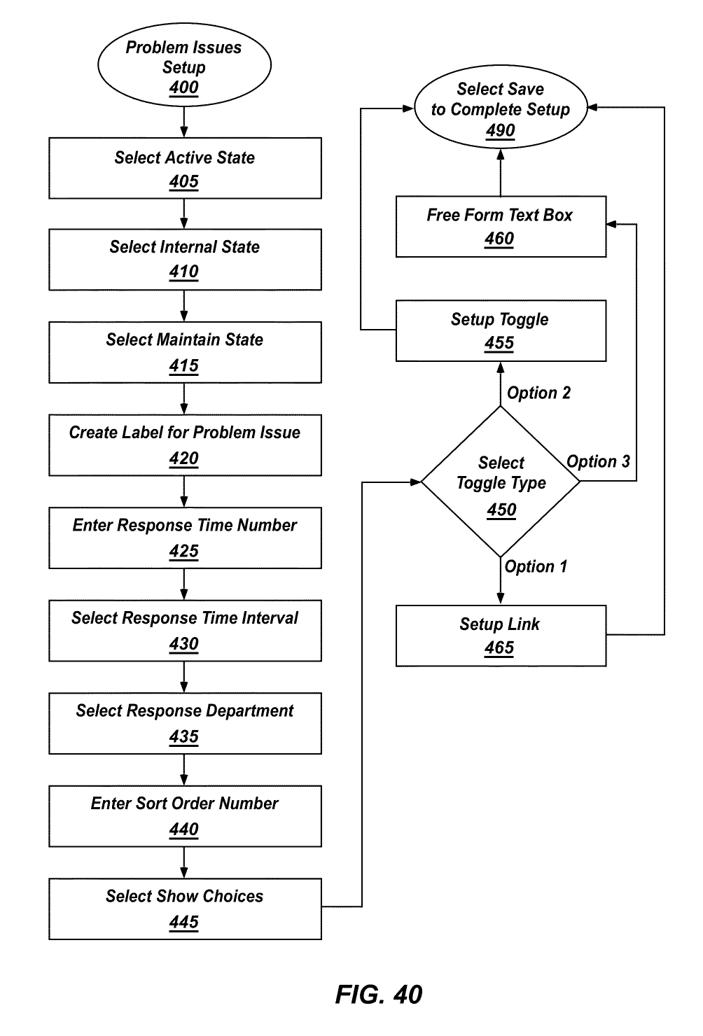

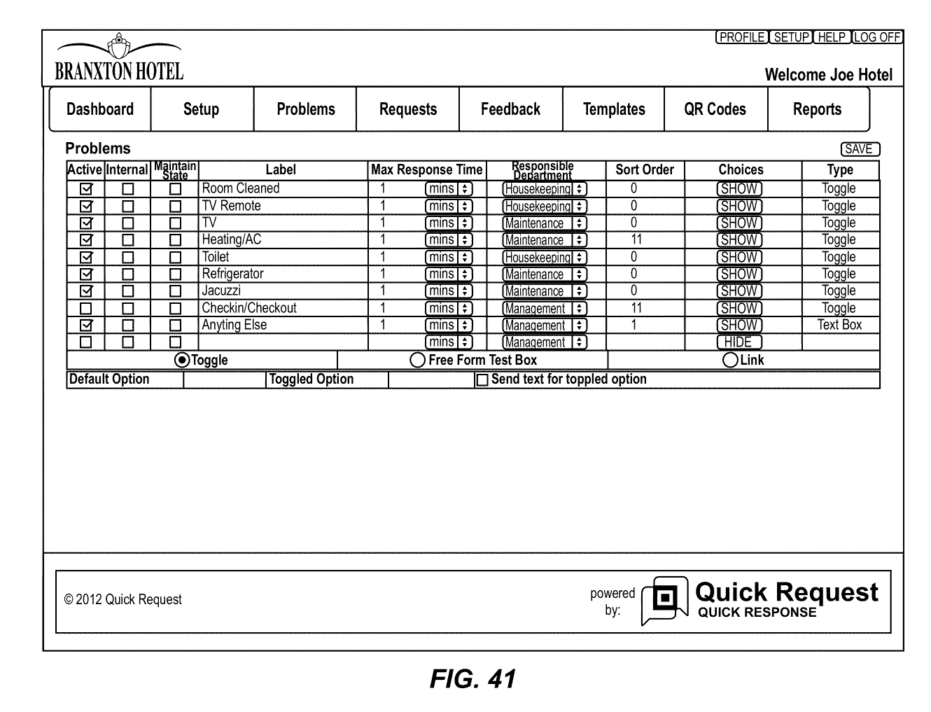

Referring now to FIG. 40, a flow diagram depicts the process 400 of setting up problem issues for the mobile sub menu items shown at 140. The administrator selects the Problem tab (see FIG. 41) and is presented with a table to enter data and select options for setting up each problem issue. The first column is select active state, shown at 405 is used to determine if the problem is active and will display on the mobile phone sub menu screen at 140 or inactive as in not check and it will not show. The second column select internal state at 410 if checked will make the issue only appear on the mobile phone screens of employees. If not checked then employees and customers could see the issue. The third column Select Maintain State shown at 415 if checked by the administrator, then on the mobile submenu at 140 if a user selects a toggle type and changes its state, then the next time he comes back to that screen the state is maintained as opposed to 415 not being checked and then it is reset back to the default state with each selection of the 140 mobile submenu. The Create a label step shown at 420 for the problem is where the administrator can type content to be displayed on the 140 mobile submenus. The Enter Response Time Number is set up at 425 so the administrator can enter a number to be the length of time before an issue is escalated to the supervisor of the first line responder or to the manager of that supervisor. The Select Response Time Interval at 430 is where the administrator can select the length of the interval in minutes, hours or days in respect to the number entered in 425.

The administrator can then select the Responsible Department at 435 from a drop down list that was auto-generated from the content entered in at Step 2 of the Company Setup Process shown at 320 of FIG. 30 and FIG. 32. The selection of Responsible department at 435 is used for the system to know which department will be sent the text message or email concerning the problem that was selected by the mobile user. The rest of the routing of the text message or email is determined, by what QR code was scanned and what area of the department the QR code is assigned to and what employee is checked into covering that area of that department. The Sort Order step at 440 is used to force an order on the mobile phone 140 submenu list and is determined by ascending numbers. Numbers can be repeated and if they are, the system will then alphabetize the items with the same number. If nothing is entered then the system automatically alphabetizes the menu items for display. The numbers do not have to be sequential, as the system will order them based on their ascending order even if numbers are skipped.

The next column deals with selecting the type of toggle at 445 to be displayed. The essence of the invention to allow users to communicate without typing a lot of information is found in the toggle types as they are called. When the administrator hits the show button they are presented with a set of toggle types organized with radio buttons. Only one toggle type can be selected for any problem issue. Once a toggle type like toggle at 455 is selected a set of additional parameters will be presented. The toggle at 455 is used to display a simple button toggle that can be slid left or right to change its state. The default option for problems will be displayed on the 140 mobile submenu each time it is selected as long as the Maintain State at 415 is not checked. The default toggle label can be set by the user and could be any word. Examples of default toggle labels are, good, ok, clean, etc. They are typically the state of the label issue that is positive and in this state no issue is reported on send. The Toggled Option can be labeled by the administrator to any word that depicts the problem state of the issue, such as words like bad, out, dirty, etc. The next parameter under the Toggle option at 455 is a checkbox as to whether or not to send a text or email if the state is changed to the toggled option. If checked then the system will send the text message or email on send. If not then the issues is logged into the system, but no one is notified to take care of the problem.

The next toggle type is called a Free Form Text Box at 460. This is simply a text box on the mobile submenu at 140 that a user could enter text to describe a problem that was not covered by the administrator on the list created for mobile submenu at 140. It is used sparingly and if users continue to report an issue the administrator could create a new problem issue to cover that issue for future 140 mobile submenus.

The third option is called a Link shown at 465. When selected it brings up a text box below the issue for the administrator to enter a URL address. This can be used to link to videos on YouTube, downloadable PDF or text documents or to take a mobile user to any specific web page on the Internet. This can be used for troubleshooting problems and to provide training so the user may be able to solve their problem with the new information without notifying someone to come help them solve the problem. Additional toggle types are being created and this is one area of the program that will most likely continue to develop. The last column displays the toggle type selected and is filled in when the user hits save. Once saved the toggle type cannot be changed. All other data concerning the issue can be modified at any time. The toggle type is not changed because it feeds reports and dashboard graphs that feed off of the toggle type. If a user wishes to have the same issue in a different toggle type he can make the previous issue inactive by unchecking the Active checkbox and then creating a new issue with the different toggle type.

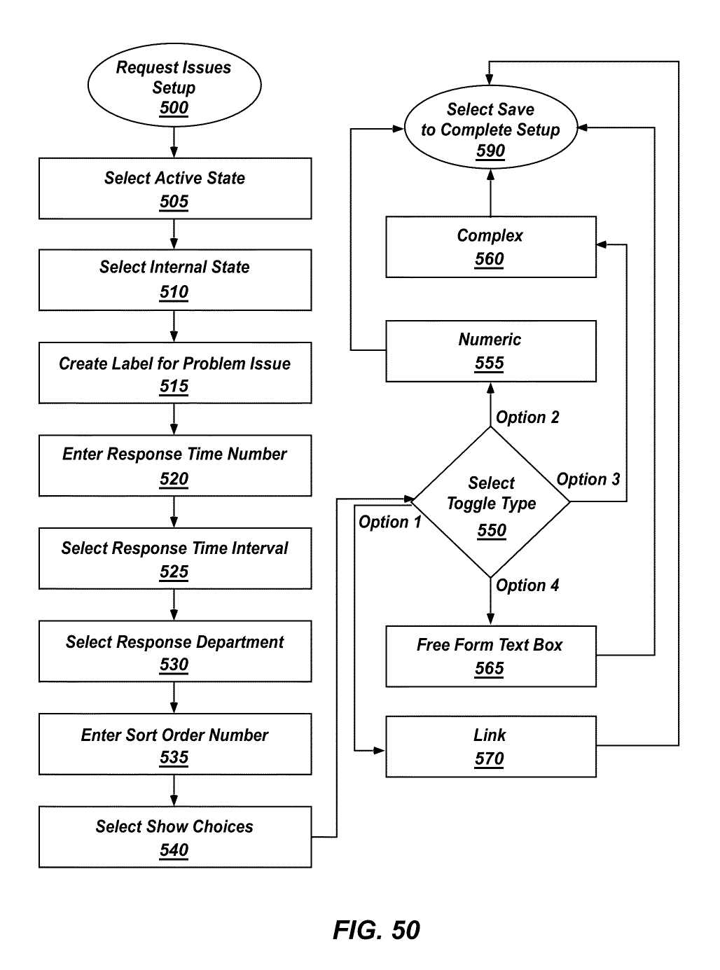

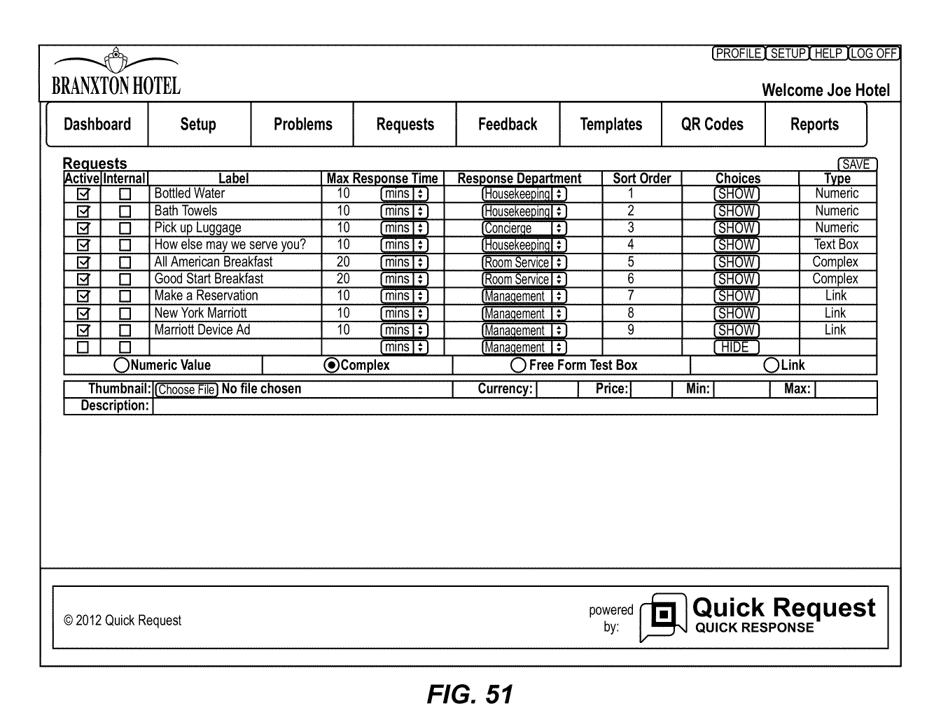

Referring now to FIG. 50, a flow diagram depicting the process 500 of setting up request issues for the mobile sub menu items at 140. The administrator selects the Request tab (see FIG. 51) and is presented with a table to enter data and select options for setting up each request issue. The first column at 505 select active state is used to determine if the request is active and will display on the mobile phone 140 sub menu screen or inactive as in not check and it will not show. The second column select internal state shown at 510, if checked, will make the issue only appear on the mobile phone screens of employees. If not checked, then employees and customers could see the issue. The Create a label at 515 for the request is where the administrator can type content to be displayed on the 140 mobile submenus. The Enter Response Time Number at 520 is set up so the administrator can enter a number to be the length of time before an issue is escalated to the supervisor of the first line responder or to the manager of that supervisor. The Select Response Time Interval at 525 is where the administrator can select the length of the interval in minutes, hours or days in respect to the number entered in 520.

The administrator can then select the Responsible Department at 530 from a drop down list that was auto generated from the content entered in at Step 2 of the Company Setup Process shown at 320 of FIG. 30 and FIG. 32. 530 selection of Responsible department is used for the system to know which department will be sent the text message or email concerning the request that was selected by the mobile user. The rest of the routing of the text message or email is determined, by what QR code was scanned and what area of the department the QR code is assigned to and what employee is checked into covering that area of that department. The Sort Order shown at 535 is used to force an order on the mobile phone 140 submenu list and is determined by ascending numbers. Numbers can be repeated and if they are, the system will then alphabetize the items with the same number. If nothing is entered then the system automatically alphabetizes the menu items for display. The numbers do not have to be sequential, as the system will order them based on their ascending order even if numbers are skipped.

The next column deals with selecting the type of toggle at 540 to be displayed. The essence of the invention to allow users to communicate without typing a lot of information is found in the toggle types as they are called. When the administrator hits the show button he is presented with a set of toggle types organized with radio buttons. Only one toggle type can be selected for any request issue. The first toggle type is called Numeric shown at 555. This type of request displays a number wheel on the phone 140 mobile submenu and allow the end user to select a number which is related to the quantity of the request demanded. The toggle type has one parameter field, which is the maximum number for the number wheel. If the users, for example, can only request 2 towels then the maximum number would be set to 2. By default the initial number is set to zero.

The second toggle type is a complex toggle that involves several different elements in a single toggle type. For example, the administrator could select to upload a picture of the item to be requested, provide a currency symbol to be displayed, a price to be displayed, and a description of the item. In addition to what he could select, the system can display a quantity selection button and a time to be delivered clock that includes every 15 minutes from the present time for up to 24 hours into the future. A free form text box could also be added to allow the user to customize his order. For example, a complex toggle type could be for a breakfast meal, with a picture, description, price, quantity, a desired time to be delivered and a text box to, for example, cook the eggs over easy (see FIG. 13). Quick Request will continue to add different complex request types that could combine any number of elements for display and interaction with the mobile end user. FIG. 13 is only a sample of one complex type.

The next toggle type is the Free Form Text Box shown at 565. This is simply a text box on the mobile submenu at 140 that a user could enter text to describe a request that was not covered by the administrator on the list created for mobile submenu at 140. It is used sparingly and if users continue to report an issue the administrator could create a new request issue to cover that issue for future mobile submenus at 140.

The third option is called a Link shown at 570. When selected it brings up a text box below the issue for the administrator to enter a URL address. This can be used to link to videos on YouTube, downloadable PDF or text documents or to take a mobile user to any specific web page on the Internet for further interaction which could include ordering products and finalizing payment by entering credit card, banking information or other payment methods. This can be used to provide marketing information, mobile ecommerce, web enabled custom customer requests that are outside of the Quick Request system, but that are found by going through Quick Request. Additional toggle types are being created and this is one area of the program that will most likely continue to develop. The last column displays the toggle type selected and is filled in when the user hits save. Once saved the toggle type cannot be changed. All other data concerning the issue can be modified at any time. The toggle type is not changed because it feeds reports and dashboard graphs that feed off of the toggle type. If a user wishes to have the same issue in a different toggle type he can make the previous issue inactive by unchecking the Active checkbox and then creating a new issue with the different toggle type.

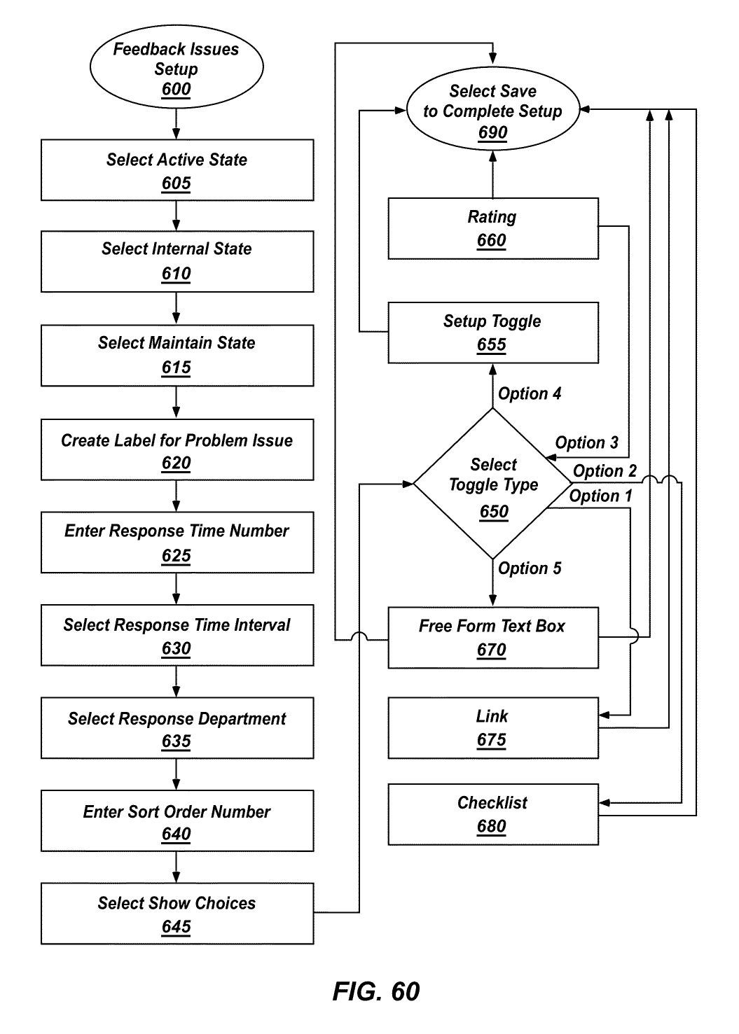

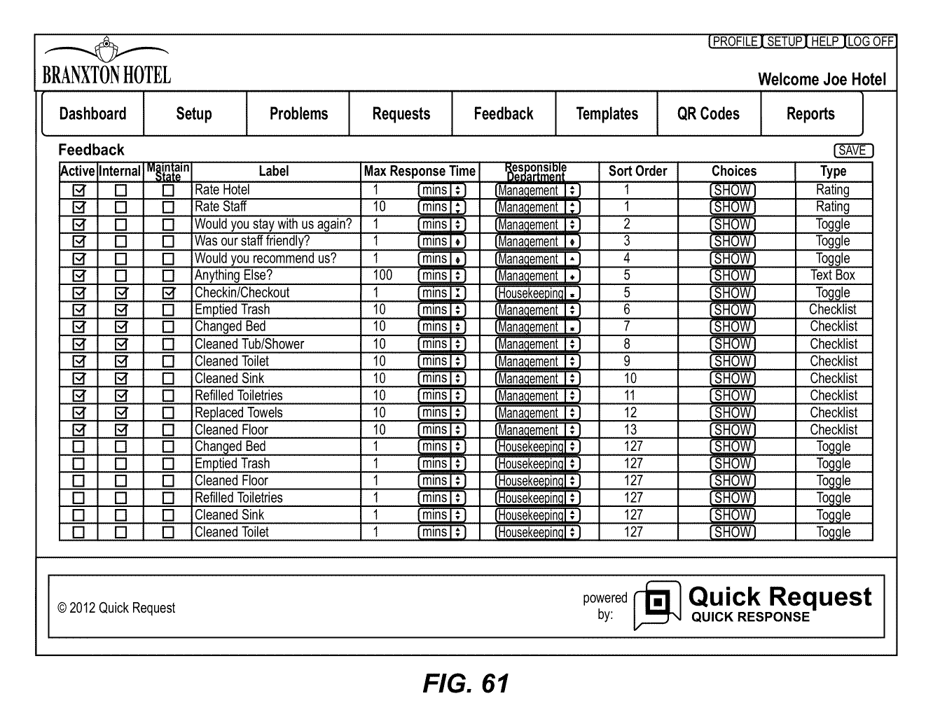

Referring now to FIG. 60, a flow diagram is shown depicting the process 600 of setting up feedback issues for the mobile sub menu items shown at 140. The administrator selects the Feedback tab (see FIG. 61) and is presented with a table to enter data and select options for setting up each feedback issue. The first column is 605 select active state is used to determine if the feedback is active and will display on the mobile phone sub menu screen at 140 or inactive as in not check and it will not show. The second column select internal state at 610, if checked, will make the issue only appear on the mobile phone screens of employees. If not checked then employees and customers could see the issue. The third column Select Maintain State at 615 if checked by the administrator then on the mobile submenu at 140 if a user selects a toggle type and changes its state then the next time they come back to that screen the state is maintained as opposed to not being checked at 615 and then it is reset back to the default state with each selection of the 140 mobile submenu. The Create a label at 620 for the feedback is where the administrator can type content to be displayed on the mobile submenus at 140. The Enter Response Time Number at 625 is set up so the administrator can enter a number to be the length of time before an issue is escalated to the supervisor of the first line responder or to the manager of that supervisor. The Select Response Time Interval at 630 is where the administrator can select the length of the interval in minutes, hours or days in respect to the number entered in 625.

The administrator can then select the Responsible Department at 635 from a drop down list that was auto generated from the content entered in at Step 2 of the Company Setup Process at 320 of FIG. 30. Selection of Responsible department at 635 is used for the system to know which department will be sent the text message or email concerning the feedback that was selected by the mobile user. The rest of the routing of the text message or email is determined, by what QR code was scanned and what area of the department the QR code is assigned to and what employee is checked into covering that area of that department. The Sort Order at 640 is used to force an order on the mobile phone 140 submenu list and is determined by ascending numbers. Numbers can be repeated and if they are, the system will then alphabetize the items with the same number. If nothing is entered then the system automatically alphabetizes the menu items for display. The numbers do not have to be sequential, as the system will order them based on their ascending order even if numbers are skipped.

The next column deals with selecting at 645 the type of toggle to be displayed. The essence of the invention to allow users to communicate without typing a lot of information is found in the toggle types as they are called. When the administrator hits the show button they are presented with a set of toggle types organized with radio buttons. Only one toggle type can be selected for any feedback issue. Once a toggle type like Toggle at 655 is selected a set of additional parameters will be presented. The Toggle at 655 is used to display a simple button toggle that can be slid left or right to change its state. The default option for feedback will be displayed on the mobile submenu at 140 each time it is selected as long as the Maintain State at 615 is not checked. The default toggle label can be set by the user and could be any word. Examples of default toggle labels are, yes, good ok, etc. They are typically the state of the label issue that is positive and in this state no issue is reported on send. The Toggled Option can be labeled by the administrator to any word that depicts the feedback state of the issue. This could be words like no, bad, etc. The next parameter under the Toggle option at 655 is a checkbox as to whether or not to send a text or email if the state is changed to the toggled option. If checked then the system will send the text message or email on send. If not then the issues is logged into the system, but no one is notified to take care of the feedback.

The next toggle type is called a Rating shown at 660 and displays on the mobile submenu at 140 a five star rating where the mobile end user can select any star from left to right leaving the stars to the left of the one selected as not colored and thus, if they selected the 3^{rd} star the first three stars would be highlighted and the rating would be three stars. The first parameter to be set is the default number of stars to be selected. The second parameter to set on this toggle type is the level at which the administrator would like a text message or email to be sent to the first responder. If it is set to 5 stars then all ratings will be sent in text form to the first responder. If it is set to zero then no texts or emails will be sent to the first responder and the feedback will only be recorded in the database. If the user selects 3, then all ratings 3 and below will be texted or emailed to the first responder.

The Free Form Text Box shown at 670 is the next toggle type. This is simply a text box on the mobile submenu at 140 that a user could enter text to describe feedback that was not covered by the administrator on the list created for mobile submenu at 140. It is used sparingly and if users continue to report an issue the administrator could create a new feedback issue to cover that issue for future mobile submenus at 140.

The third option is called a Link shown at 675. When selected it brings up a text box below the issue for the administrator to enter a URL address. This can be used to link to videos on YouTube, downloadable PDF or text documents or to take a mobile user to any specific web page on the Internet.

The next toggle type is checklist shown at 680. When selected by the administrator, it will display a check box in front of each label on the mobile submenu at 140. The mobile end user can then touch each checkbox to toggle it as checked or not. The options that can be selected by the user are initially checked if the administrator wants all the checkboxes checked by default. Escalate if checked if the administrator wants a text message or email to be sent when the mobile user hits send and the state is checked. And the final parameter is Escalate if not checked, which if selected by the administrator will send a text message or email to the first responder if the checkbox on the 140 mobile submenu is not checked. Additional toggle types are being created and this is one area of the program that will most likely continue to develop. The last column displays the toggle type selected and is filled in when the user hits save. Once saved the toggle type cannot be changed. All other data concerning the issue can be modified at any time. The toggle type is not changed because it feeds reports and dashboard graphs that feed off of the toggle type. If an administrator wishes to have the same issue in a different toggle type he can make the previous issue inactive by unchecking the Active checkbox and then creating a new issue with the different toggle type.

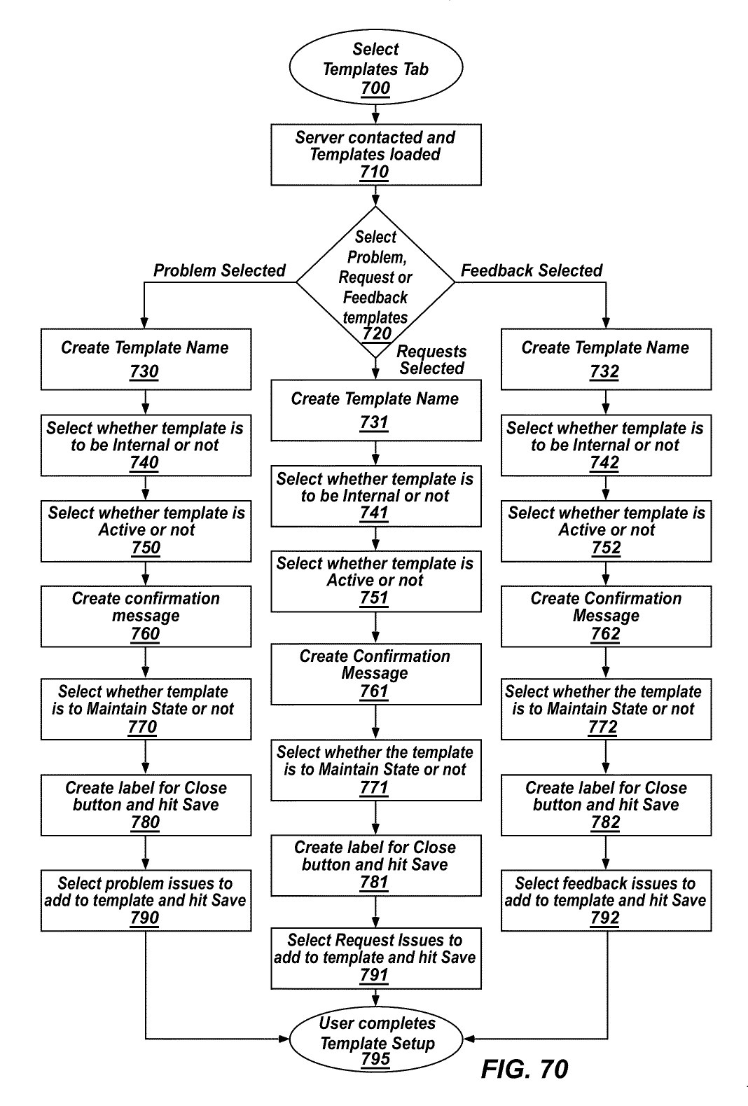

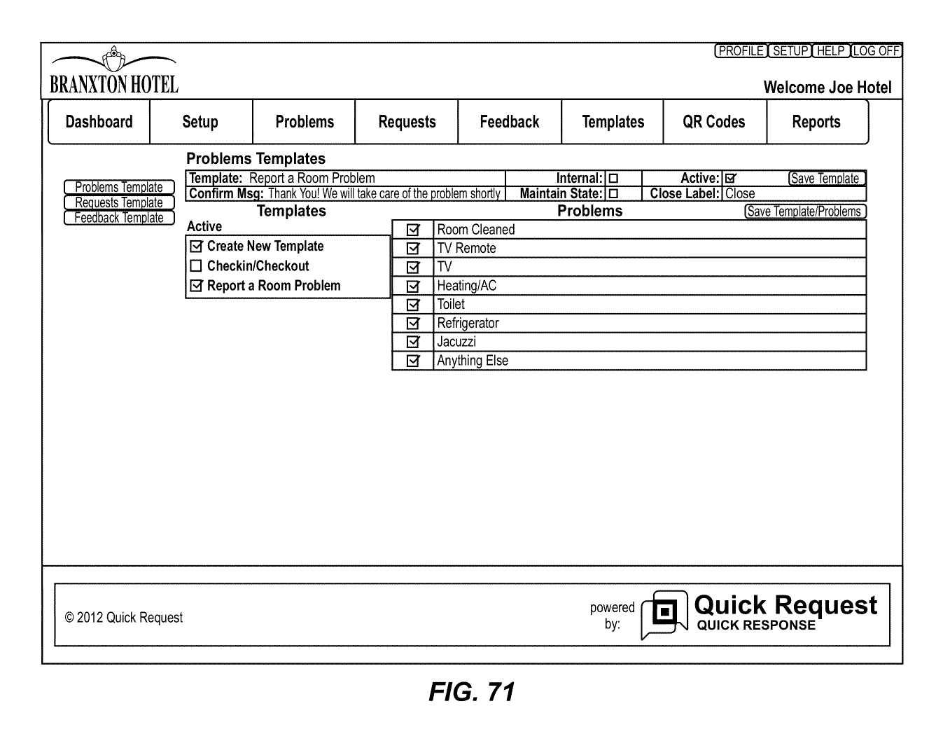

Referring now to FIG. 70, a flow diagram depicts the process 700 of setting up main templates for the mobile main menu items at 130. The administrator selects the Templates tab (see FIG. 71) and is presented three types of templates that can be created, problem templates, request templates, and feedback templates.

When an administrator chooses to create a problem template he selects the problem template option at 720, creates the template name at 730, selects whether the template is to be internal or not at 740, meaning that it would be viewed only by employees and not guests or customers of the system, selects whether the template is active or not at 750, which determines if it is to be displayed on the mobile device or not, creates a confirmation message at 760 that will be presented to the mobile end user after he hits send, selects whether the template is to maintain its state or not at 770 between usage or by default will be reset back to its default state, and finally creates a label for the close button at 780 for the confirmation message and hits save. After he has created the problem issues template at 730 he can then select the items at 790 from the list of problems on the screen that will be included as the submenu of items at 140 on the mobile web application and hit save.

When an administrator chooses to create a request template he selects the problem template option at 720, creates the template name at 731, selects whether the template is to be internal or not at 741, meaning that it would be viewed only by employees and not guests or customers of the system, selects whether the template is active or not at 751, which determines if it is to be displayed on the mobile device or not, creates a confirmation message at 761 that will be presented to the mobile end user after he hits send, selects at 771 whether the template is to maintain its state or not between usage or by default will be reset back to its default state, and finally creates at 781 a label for the close button for the confirmation message and hit save. After he has created the request issues template at 731 he can then select at 791 the items from the list of problems on the screen that will be included as the submenu of items at 140 on the mobile web application and hit save.

When the administrator chooses to create a feedback template he selects the problem template option at 720, creates the template name at 732, selects at 742 whether the template is to be internal or not, meaning that it would be viewed only by employees and not guests or customers of the system, selects at 752 whether the template is active or not, which determines if it is to be displayed on the mobile device or not, creates at 762 a confirmation message that will be presented to the mobile end user after he hits send, selects at 772 whether the template is to maintain its state or not between usage or by default will be reset back to its default state, and finally creates at 782 a label for the close button for the confirmation message and hits save. After he has created the problem issues template at 732 he can then 792 select the items from the list of problems on the screen that will be included as the submenu of items at 140 on the mobile web application and hit save.

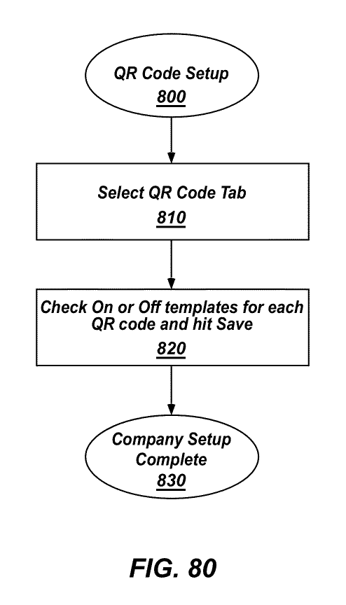

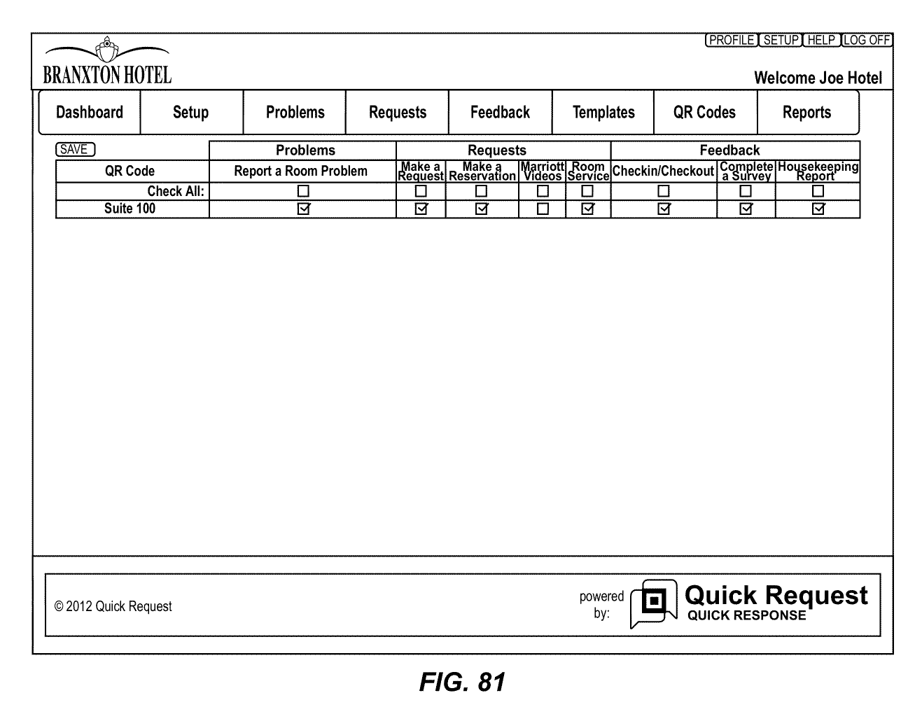

Referring now to FIG. 80, a flow diagram depicts the process 800 of setting up templates to be displayed with individual QR codes for the mobile main menu items at 130. The administrator selects the QR codes tab shown at 810 (see FIG. 81) and is presented with a list of all of the QR codes created for this account down the left side of a table. Across the top he is presented with the names of the problem, request, and feedback templates that were created in FIG. 70 and process 700. They are organized in alphabetical order within each category. There is a Check All check box at the top of each column allowing the user to either add or remove a template from all QR codes at one time. He checks at 820 on or off any templates for each QR code and hits save. This process enables the system to know what to display on the 130 main menu screen on the mobile web application.

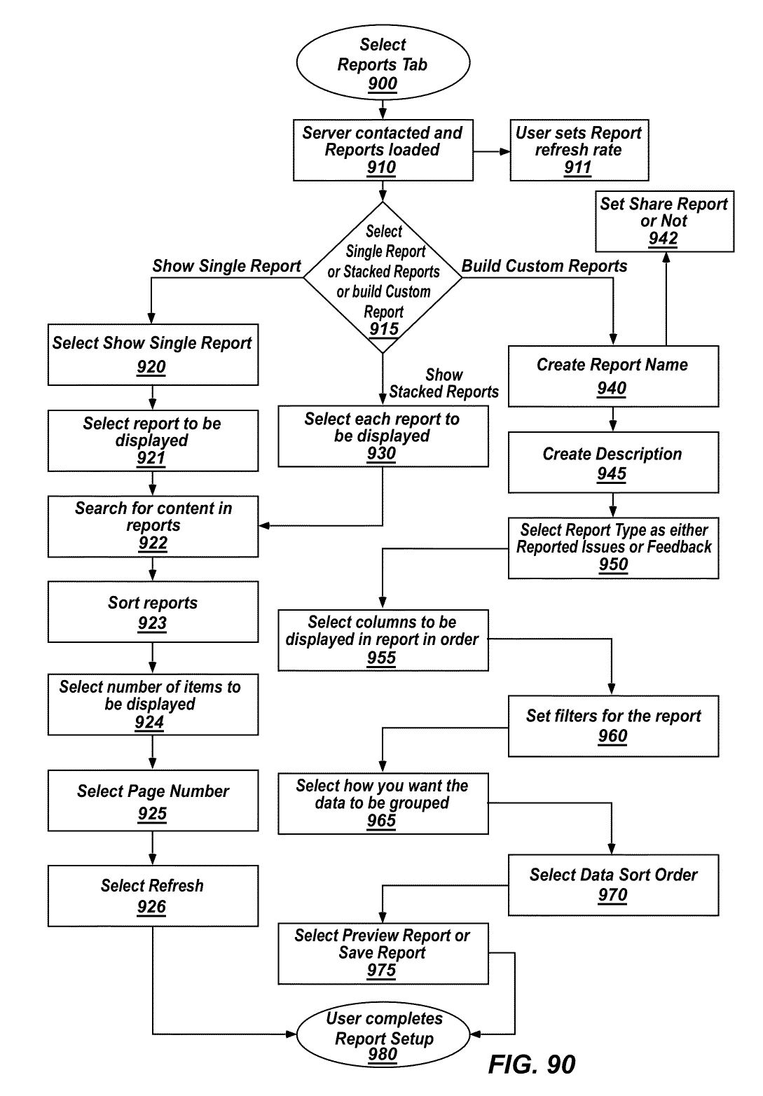

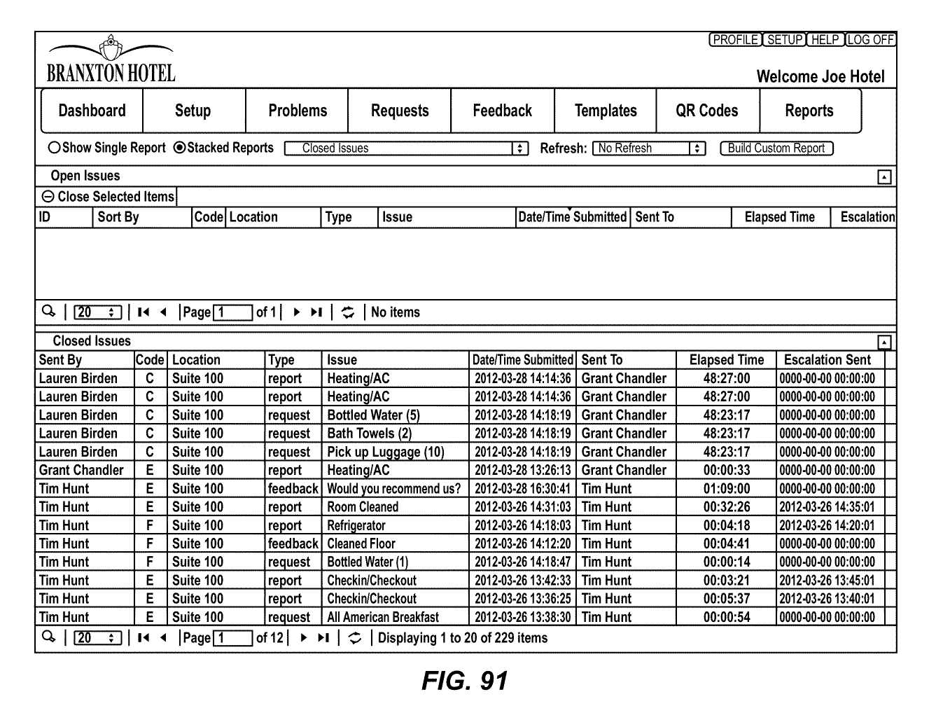

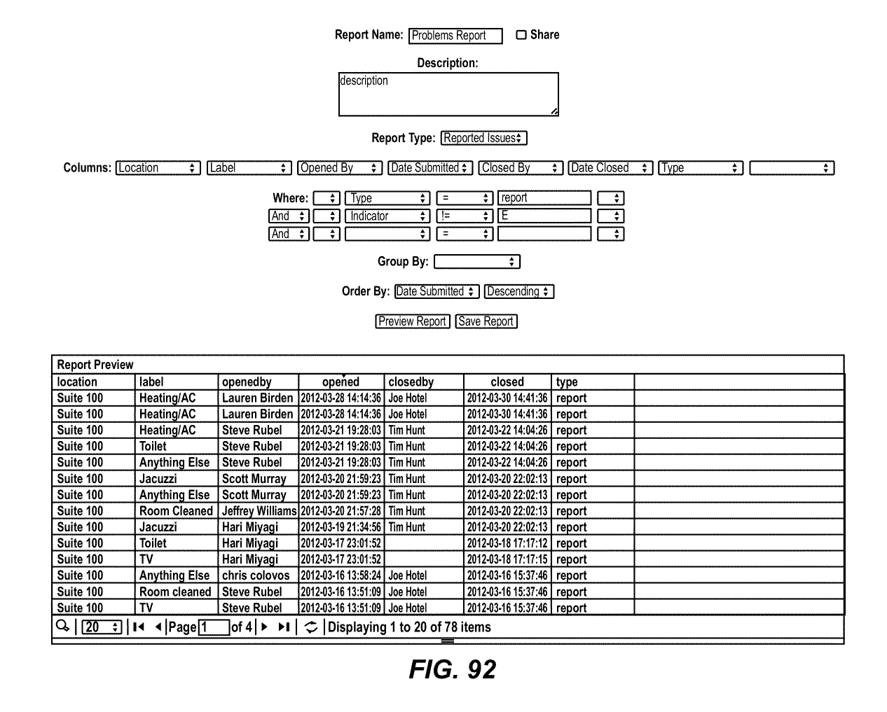

Referring now to FIG. 90, a flow diagram depicting the process 900 of setting up Reports to include displaying reports one at a time, stacked and building custom reports. The administrator selects the Reports tab at 900 (see FIG. 90) and the server loads the reports at 910. The administrator can choose to have the reports refreshed at 911 at different intervals to keep the content on the screen current. The administrator can then select to either view one Single Report at 915 or show multiple reports stacked on the screen at 915. Once he has selected either option 920 single report or 930 stacked reports, he selects the report 921 or reports 930 to display the single reports or the stacked reports. Once the reports are displayed the administrator can then search the content of the report at 922 for any column narrowing the report down further. The administrator can also sort the reports at 923 from any column heading by selecting the heading. The administrator can also select the number of report items at 924 to be shown on the page at any one time from 10 to 50. The administrator can also select the page number for the report at 925 if it covers multiple screens. And finally the administrator can select at 926 to refresh the report at any time to make sure the report has the most current information.

If the administrator selects the Build Custom Reports (see exhibit 19) button at 915 a separate screen opens with the report builder. The administrator creates the name of the report at 940, decides if the report should be shared across the industry at 942, creates a description for the report at 945, selects the report type at 950 as either Reported Issues or Feedback, selects at 955 what columns are to be displayed in the report and in what order, sets filters for the report at 960 to customize the view of the report, selects at 964 how the data is to be grouped in the report, determines at 970 the sort order of the report and what field the sort order is read from, and finally the administrator can preview the report at 975 and if acceptable save the report to their list of custom reports on the main report screen.

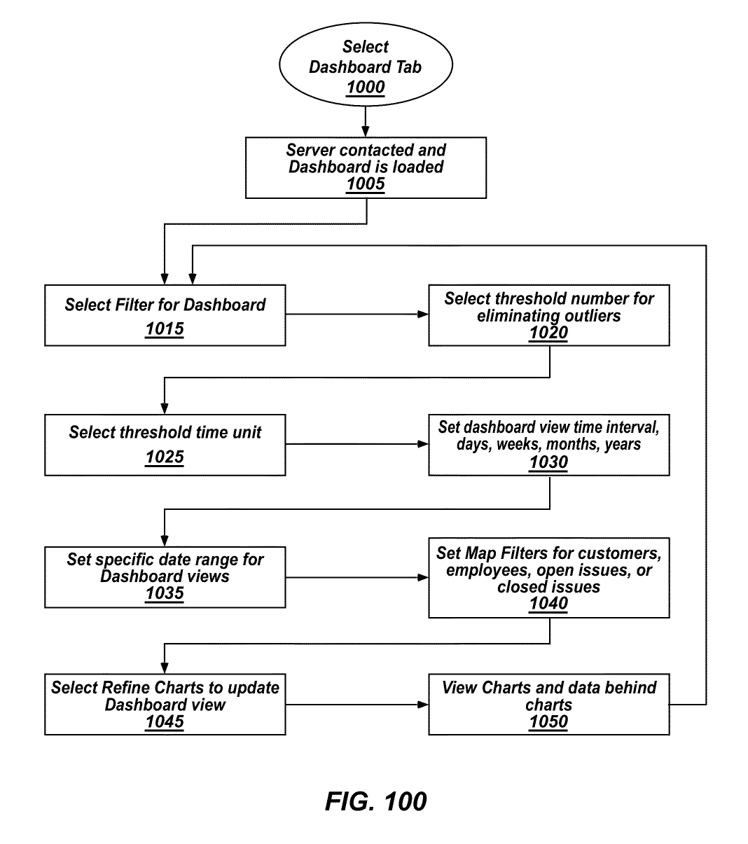

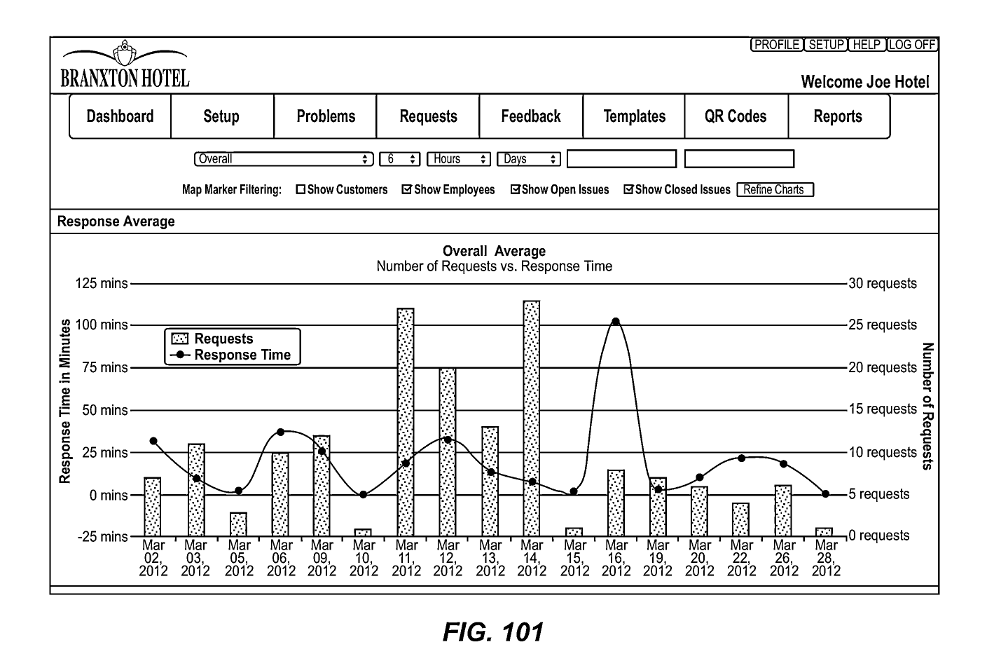

Referring now to FIG. 100, a flow diagram depicts the process 1000 of setting up and viewing Dashboards to include displaying dashboards such as the Response Average, Survey Results/Rating, Survey Results/Feedback, Survey Results/Comments, and Time tracking map. The administrator selects the Dashboard tab at 1000 (see FIG. 101) and the server at 1005 loads the dashboard. The administrator can then filter the dashboard at 1015 with the Overall drop down. The administrator can filter by departments, roles or areas, employees and even individual issues within the system. The administrator can then select the threshold number at 1020 to eliminate elapsed time outliers of issues that may have not been closed in a reasonable time frame. By setting this number, the administrator eliminates those items outside that threshold from being averaged into the dashboards. The administrator can then select the time unit at 1025 either hours or minutes for the threshold filter. The administrator can then set the dashboard time view interval at 1030 by selecting either days, weeks, months or years to view a comparison of the work load and average time for each time period. The administrator can also set a start and stop date at 1035 for the dashboard to limit the views even further. The administrator can also set filters at 1040 for the time track map view to set whether the customers, employees, open issues and or closed issues are displayed on the map. When the administrator has completed setting the dashboard views he can then hit the refine charts button at 1045 to update the view with the parameters they have set. The administrator can then view the reports and repeat the process as needed to see different charts and graphs of the data.

### Mobile Phone Use to Activate Doors and Other Electronic Devices

The present invention can also be used to make a mobile phone the key to unlocking doors and activating other electronic devices. To unlock doors and or activate other electronic devices, a key of some sort is usually used. That key could be a magnetic strip or a near field communications chip or an RFID chip. These keys or devices are used to limit access to persons who have the appropriate key, chip or magnetic strip card in their possession.

Because the invention creates a unique encrypted hash code for each mobile phone user and the QR code placed on a door lock is unique to that location, a mobile phone user using the Quick Request system can be set up to provide the electronic device or door lock with a unique code to activate or unlock the device.

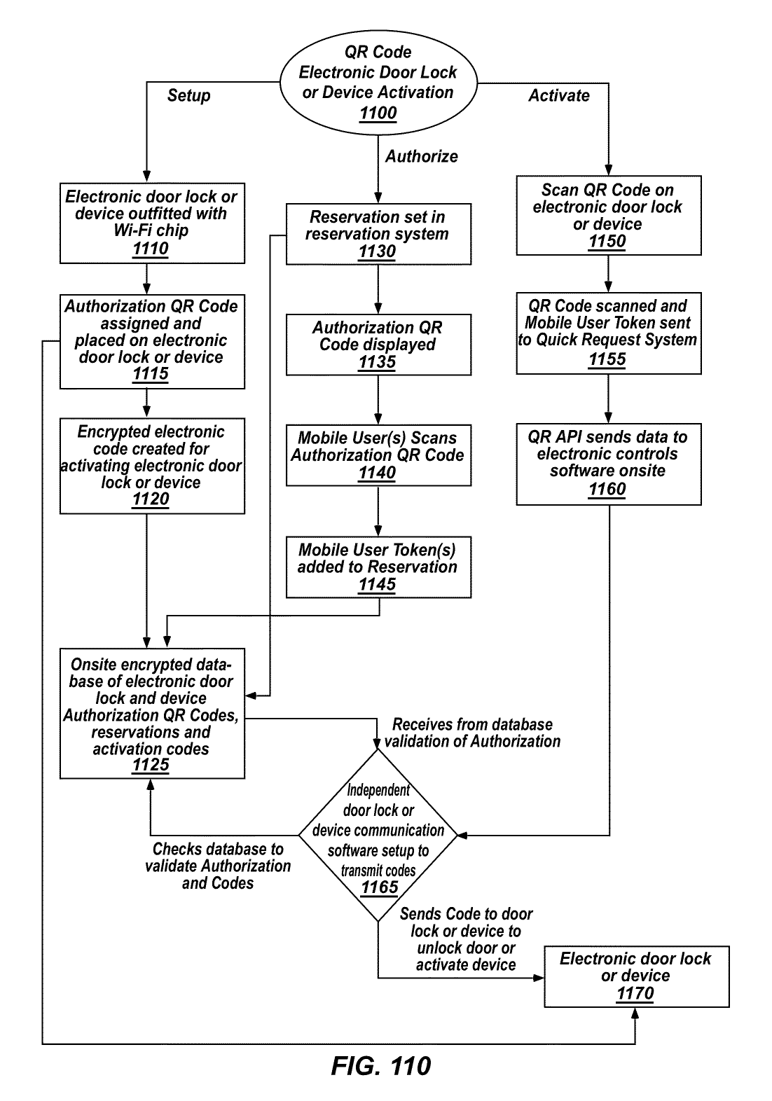

Referring now to FIG. 110, a flow diagram depicting the process 1100 of setting up QR codes and mobile smartphones to be used as electronic keys or as a means of enabling a mobile smartphone to be used as a key or switch for electronic devices and door locks. At 1110, an electronic Wi-Fi chip is added to the electronic door lock to both transmit codes to the lock like the magnetic strip of a key card does and also to receive information from the lock concerning who and when activated the lock. This information is normally stored in electronic door locks, but can now be transmitted back to the system with the addition of the Wi-Fi chip. In the QR code setup at 1115 the administrator sets up the system to generate a unique QR code for each electronic device or electronic door lock. This is done the same way as any other QR code in FIG. 30 of the Setup step 310 and FIG. 31. The QR code is then placed on the device. The Quick Request system then generates an encrypted code at 1120 for the door lock and this is sent the onsite encrypted database at 1125. At initial setup the encrypted code is sent via the door lock at 1165 and device communication software to the door lock at 1170. This initializes the lock or device.

For an individual to authorize his mobile smartphone to be used as an electronic key, he must send his token to the system that maintains the codes for unlocking or activating a device. For example, if the system was a hotel room and a reservation at 1130 was made online for the room, the user could request to have his phone unlock his door. The reservation software will state that the hotel is Quick Request-enabled for check in bypassing the front desk. If the end user wishes to use his phone to check in he will select an option on the screen to set up his phone. An authorization QR code at 1135 would be displayed on the screen generated by the Quick Request system through an API. The mobile phone user scans the QR code at 1140 and this passes a message back to the Quick Request system with the QR code scanned and the token on the users phone at 1145. This is then sent to the database at 1125 that holds the reservation information with the token and QR code scanned to validate the user. Multiple phones could scan the same QR code at step 1140 and have each phone authorized to unlock the door.

When the traveler is close to the hotel he can bring up on his phone the hotel's web site and he can then select his room number from available room numbers at his room rate. When he selects this information the system adds this to the database with their reservation at 1125. This step is done outside of the Quick Request system and is part of the hotel's reservation system. When the mobile phone user guest arrives at the hotel he goes directly to his room and scans the QR code on the door lock at 1150. This sends a message at 1155 to the Quick Request system with the room QR code scanned and the token for the mobile user. This is then sent via an API at 1160 to the independent door lock communication software at 1165. The software checks at 1165 with the database at 1125 sending the door lock code and the users token to verify that the token match the token at 1125 in the reservation for the right room number. If it does match the database at 1125 sends a message back to the controller at 1165 authorizing the door to be unlocked. The 1165 controller then sends a message to the door lock unlocking the door and the guest can enter the room.

Mobile Phone-Based Software Application for Restrooms. Mobile Phone Usage.

The following process provides an example of a mobile phone-based application of the present invention, used for maintaining restrooms. A customer uses a mobile cell phone to scan a QR code located in the restroom to download software from a website. The customer provides information to the website regarding the status of the restroom, including cleanliness and availability of paper goods and the need for service or maintenance of the restroom. The information is processed by the website, and a maintenance person is notified of the status and the need for service. A maintenance person also scan the QR code to check in when he services the restroom, and enters data about the service he has provided. Supervisory personnel are notified by the website so that they remotely monitor the status and servicing of the restroom. The notifying customer is also informed by the system that the restroom has been cleaned and maintained.

As depicted in FIG. 121, a flow chart shows a process 2100 employed by a mobile phone user upon opening the smartphone application of an embodiment of the present invention. At 2102, the user will see a loading screen, followed by an authentication step 2104. If the user has previously registered with the system, the application will take him to a home screen step 2106. If not, the user will have the choice to login with a user name and password, or proceed to the home screen step 2106 without logging in. If the user does not login, he/she will only be prevented from providing more than one restroom rating. All other functions of the application will perform as normal.

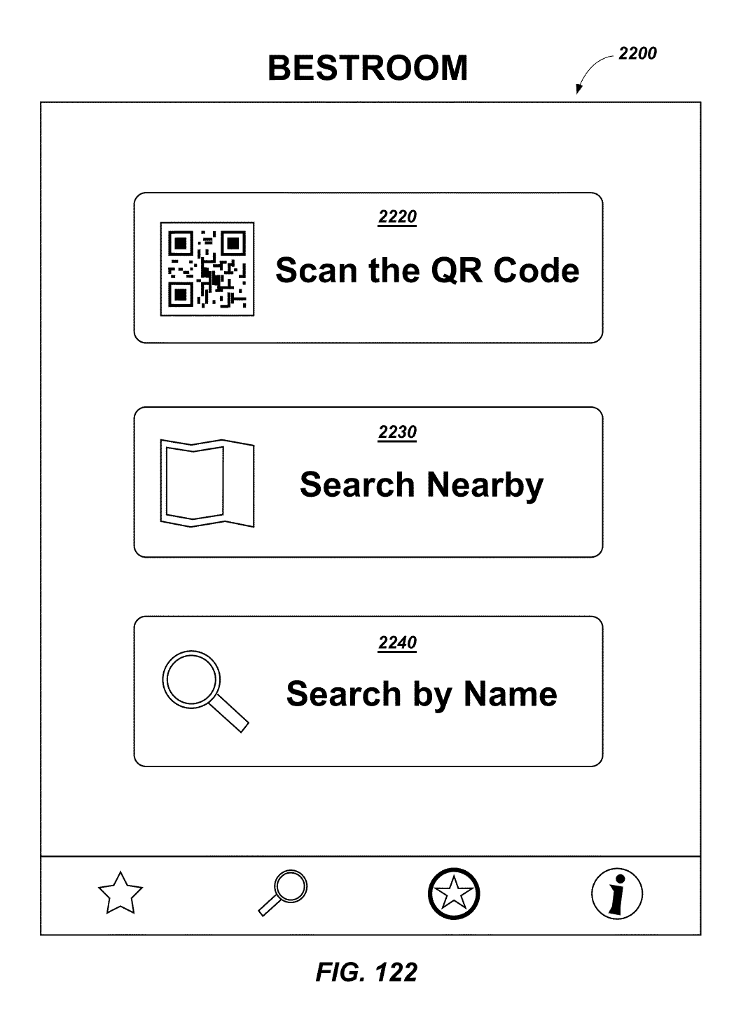

FIG. 122 shows the home screen 2200 that appears on the mobile phone screen and offers users the following options: Scan a QR code at 2220, Search Nearby at 2230 or Search by Name at 2240. In addition to the above options, an ever-present Navigation Bar 2250 at the bottom of the screen will allow users to Review, Search, show Favorite restrooms, or get information on the application.

Scan the QR Code (and Review Icon from Navigation Bar).

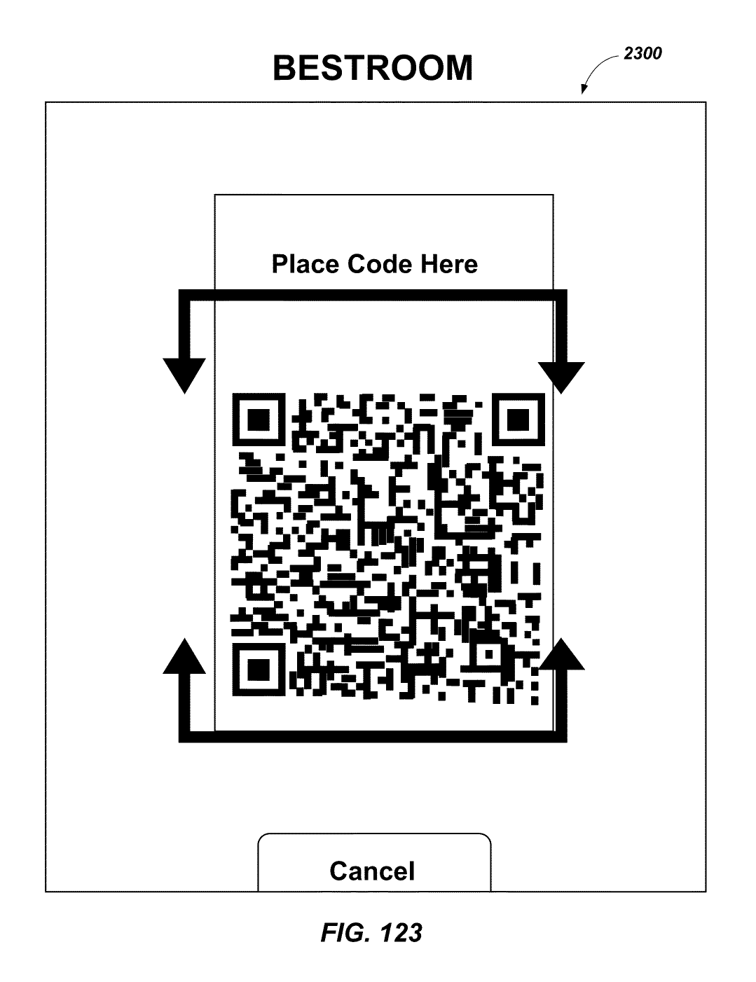

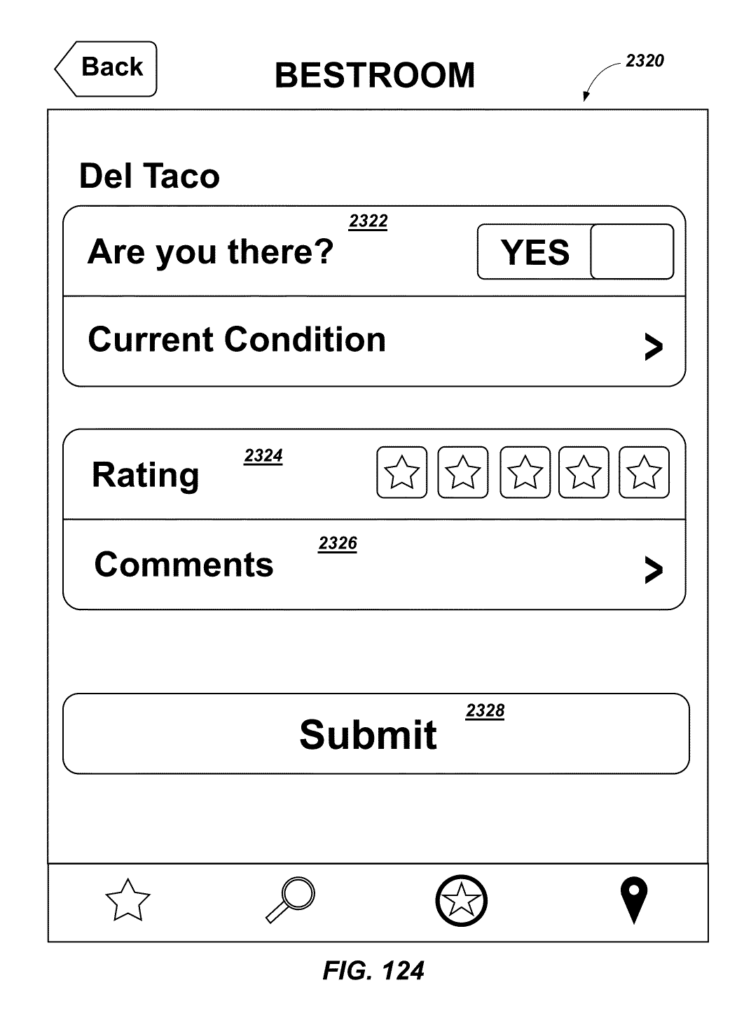

At step 2108 in FIG. 121, the user begins a review of the restroom. At step 2110 in FIG. 121, the user taps the Scan the QR Code button 2220 shown in FIG. 122. At that point the screen will change to the Scan Screen page 2300 shown in FIG. 123. The smartphone camera will be activated and as soon as it senses a QR code. It will scan the code and take the user to the summary review screen as shown at the Review page 2320, shown in FIG. 124. At this point, shown in at step 2112 in FIG. 121, the screen asks the user “are you there?” also shown at 2322 in FIG. 124. If the user is in the restroom, the user can create a simple rating by indicating a star rating (1 star being worst, 5 stars being best) shown at step 2114 in FIG. 121 and at 2324 in the Review screen shown in FIG. 124. At step 2118, a user can then click a “Submit” button 2326, which will submit the rating (to be aggregated along with all other ratings for this location).

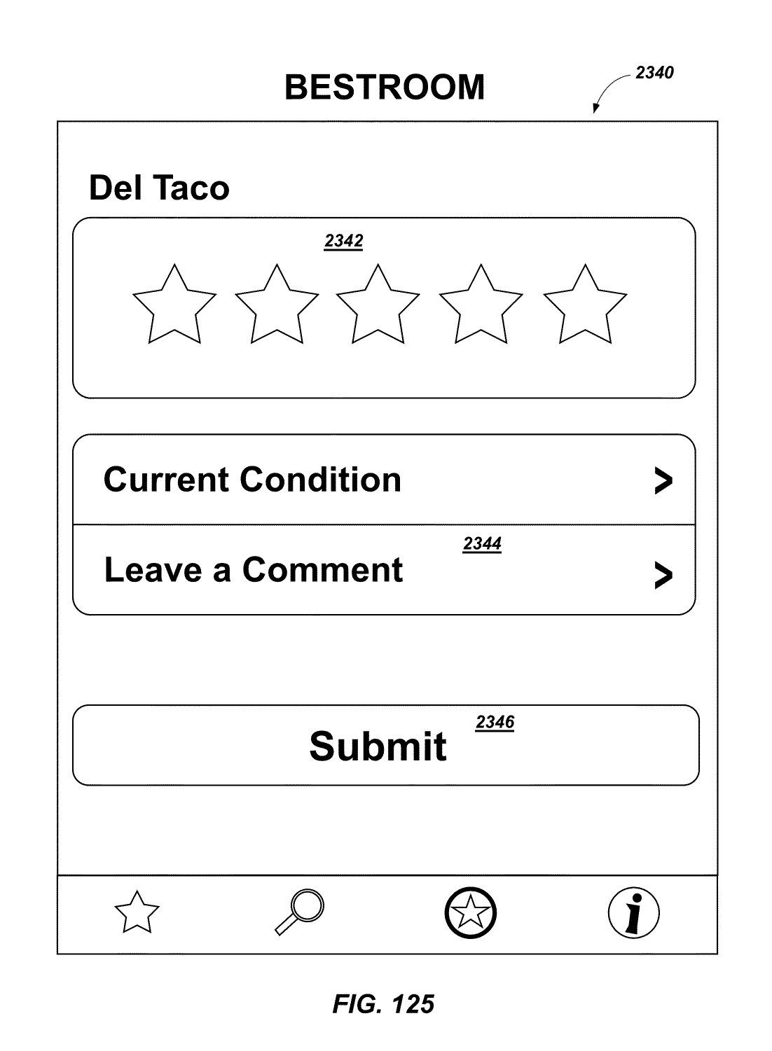

If the user is not at the reviewed location, the screen will change to a different review screen 2340, shown in FIG. 125. In that screen the user can provide a star rating at step 2120 in the flow chart of FIG. 121 and also shown at 2342 in Review screen 2340 in FIG. 125. At step 2122, a user can also leave a comment as shown at 2344 in FIG. 125. The fact that the user is not at the reviewed location is verified by the lack of a scanned QR code and/or an incorrect location as supplied by the smartphone GPS.

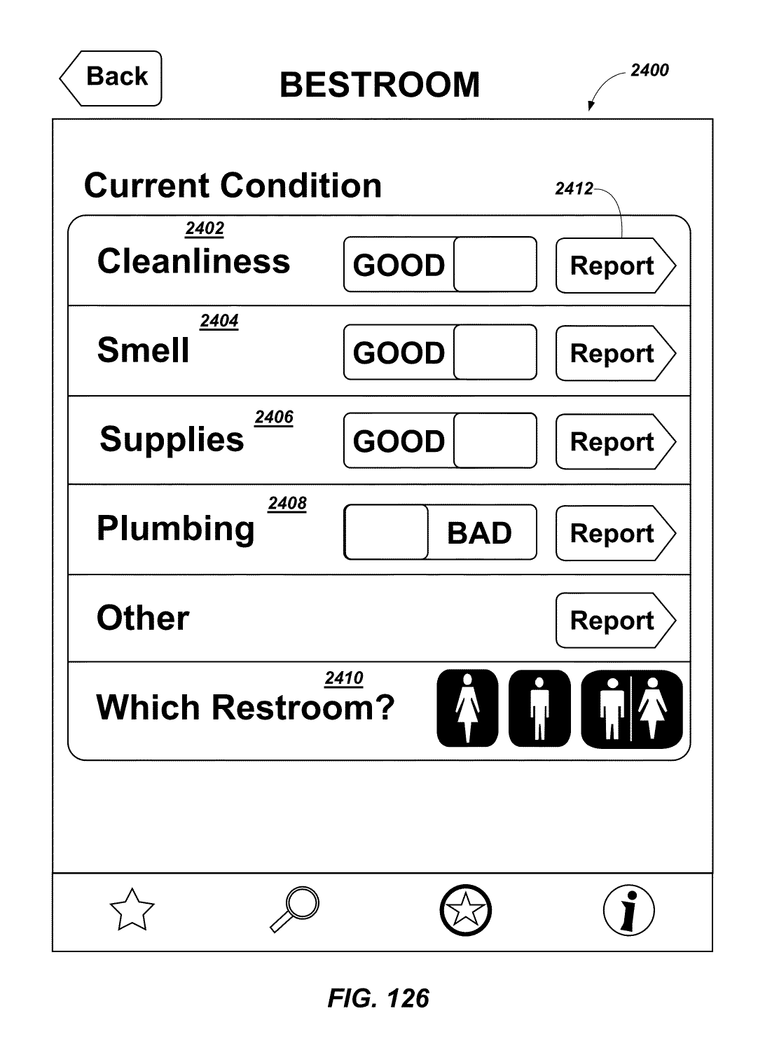

At step 2116, if, the user prefers to leave a more detailed rating, he can tap the Leave a Comment button shown at 2326 in FIGS. 124 and 344 in FIG. 125, which will present a screen (not shown) for users to leave a long-form comment. Additionally, the user may choose to tap the Current Condition button shown at 2328 in FIG. 124, which will take him to step 2128 in the flow chart shown in FIG. 121 and a new screen called the Current Condition page, shown at 2400 in FIG. 126. At this point the user can choose to indicate (via slider switches) if the restroom is clean, shown at 2402, smells good, shown at 2404, has enough supplies, shown at 406, has any plumbing or other issues, shown at 2408, and whether the user is in the men's, women's or family restroom, shown at 2410.

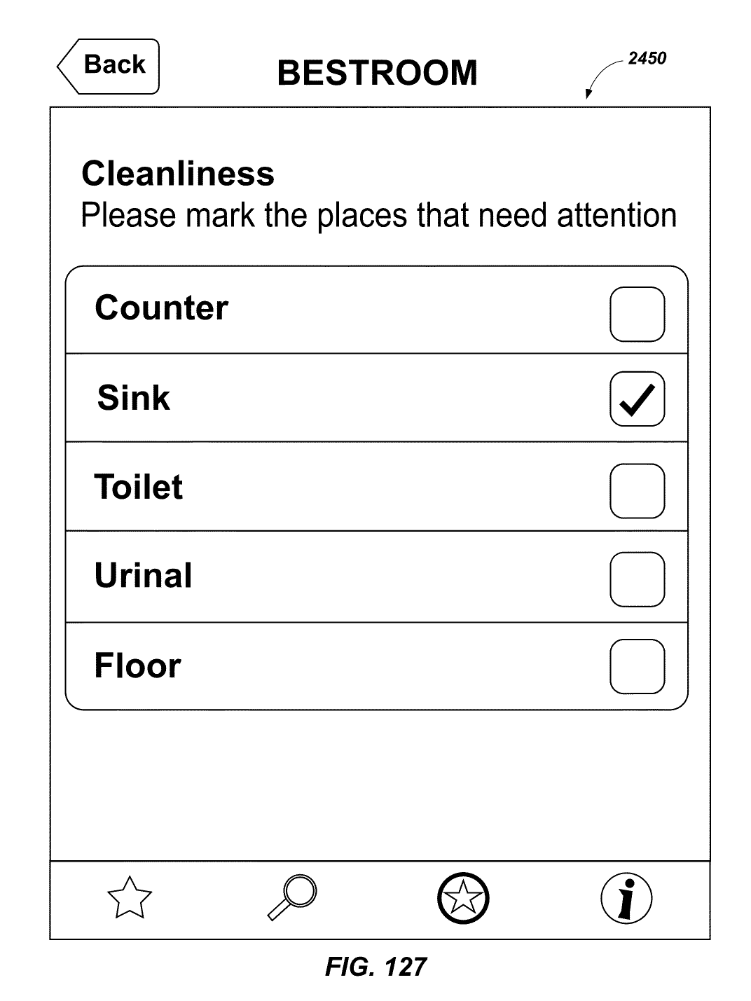

From the Current Condition Page screen shown in FIG. 126, the user can report specific issues of immediate concern by pressing any of the Report buttons, such as shown at 2412. Individual report screens will be provided for each category. As an example, FIG. 127 shows a Cleanliness Report screen 2450 reached by pushing Report button 2412 shown in FIG. 126.

When the user is completed with his report, he taps the Submit button 2328 on the Review page screen in FIG. 124 or the Submit button 2346 on the Review page screen in FIG. 125. At submission of the review, a progress and confirmation screen will appear (not shown). Once the review has been submitted to the server, the user will return back to the review step 2108 shown in FIG. 121 and to the Home Screen page 2200 shown in FIG. 122. If the user tries to enter a review and the user does not have an active network connection, the review will be stored locally on the smartphone and sent to the server the next time a network connection is active and the application is open.

The system provides for feedback to be sent to the user who submitted a review, as soon as an undesirable condition has been changed or fixed, so that the user is empowered to know that his review has made a difference, and so that the user who gave the restroom an unfavorable rating will know that he can visit the restroom in the future, because the condition has been changed.

Search Nearby (and Search Icon from Navigation Bar).

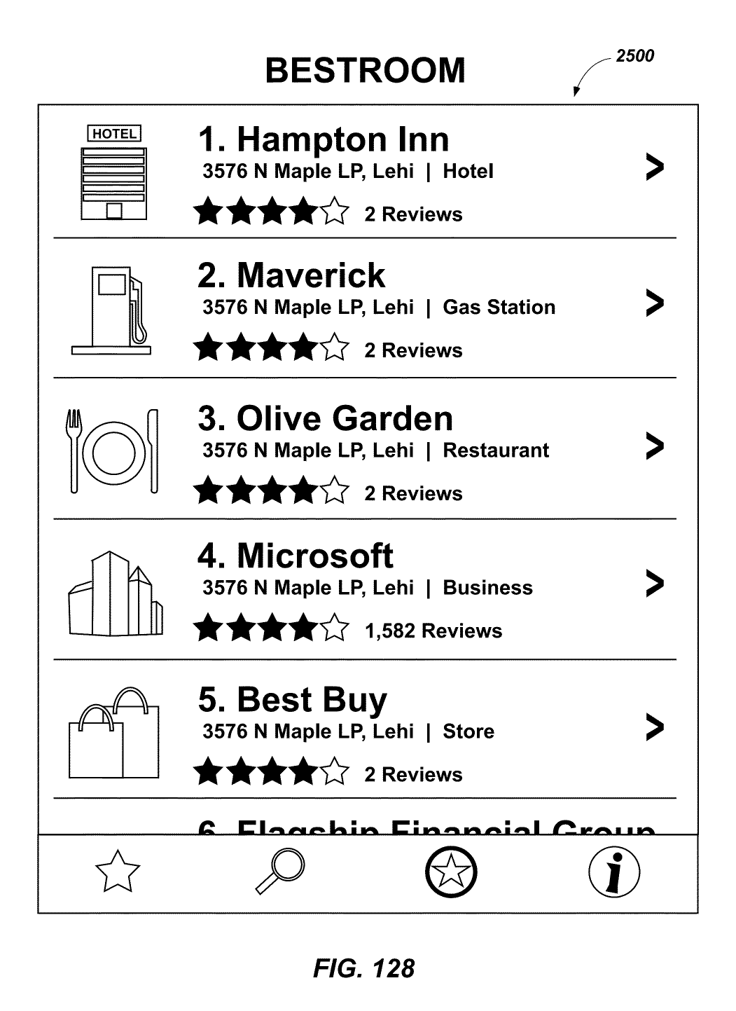

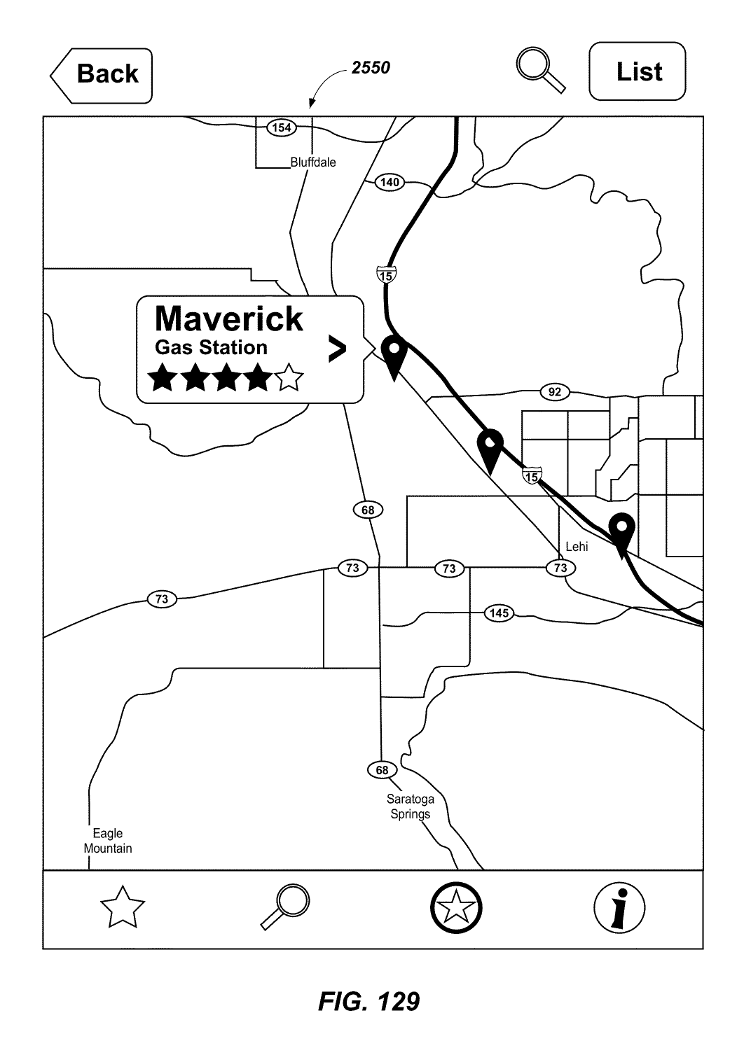

Referring to the flow chart 2100 shown in FIG. 121, at step 2130, a user can also use the current mobile phone application to locate restrooms in a selected area. This can be done at step 2132 by entering a zip code, city or state, or it can be done at step 2134 by entering a specific place or business. As shown in the Home Screen at FIG. 122, the user may tap the Search Nearby button 2230, and the smartphone application will engage the GPS to locate restrooms nearby and display them in a list 2500 in a List Screen at FIG. 128 or on a map 2550 in a Map Screen shown at FIG. 129. A user may also sort listings by rating, or filter based on the attributes shown above. A user may also look for desired amenities or a map, as shown at steps 2136 and 2138.

### Search by Name.

Referring to the Home Screen 2200 shown in FIG. 122, a user may search for a particular restroom based upon a search word or phrase entered into the search screen (not shown). Referring to the flow chart 2100 in FIG. 121, at step 2140, a user may save favorite restrooms into a list of Favorites, returning to the list whenever they like to revisit recent reviews or navigate to the Favorite restroom.

As shown at step 2145 in FIG. 121, a user may view information about the application, including copyright information, terms of use, privacy policy, and so forth.

Additional options may be included in the scope of the present invention that provide for the following additional functions. Service personnel may check-in and check-out of each restroom as they begin and complete their service of each restroom. Checking in and out are performed using the same QR codes that end users scan for providing reviews.

When service personnel check-in, any user-generated issues (cleanliness, supplies, plumbing, etc.) may be delivered to the service personnel's smartphones so that they know which issues to address first. Once those issues are addressed, the service personnel may denote these items as “fixed” in their application, thereby providing end users, restroom owners, and their own supervisors with real-time information about repaired conditions.

A restroom owner may also receive push notifications whenever end users indicate that there are conditions in need of attention. The owner may order supplies through the application software directly from its distributor or service company. A distributor and/or service company may receive alerts when its customers' restrooms are in need of service.

Interaction of Mobile Phone with Internet Database

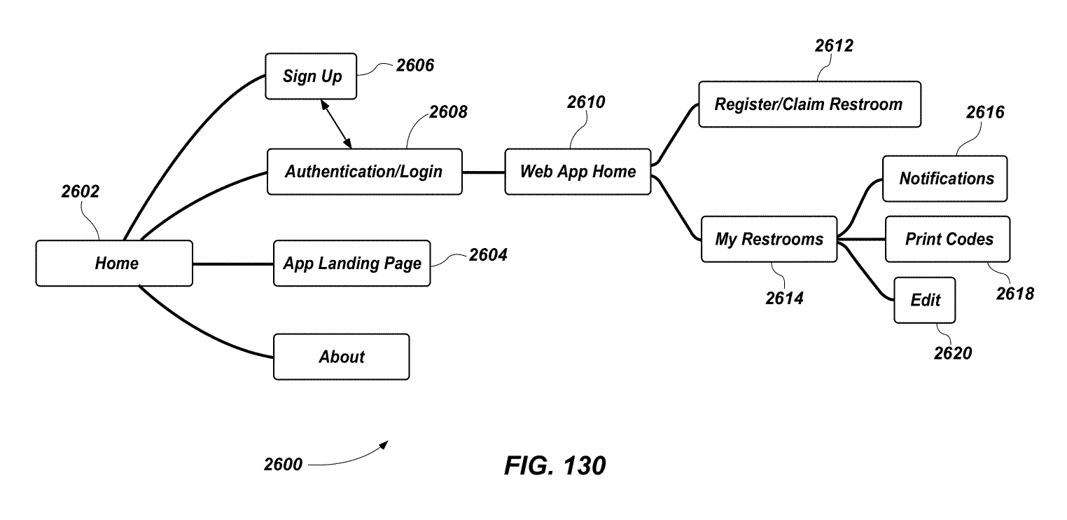

Referring now to FIG. 130, a flow diagram is shown depicting a process 2600 of accessing and processing the internet database according to an embodiment of the present invention. At step 2602, the user first comes to the Home Page (not shown) where he will obtain general information about the entire system, allowing him to navigate to additional pages as described below.

At step 2604, the user comes to the App Landing Page (not shown), which is a mobile-friendly page that allows a user to choose (via his smartphone web browser) whether he wants to install the iOS or Android application. Once chosen, the smartphone will be redirected to the iTunes App Store or Android Marketplace pages for the appropriate application so that it can be installed on the user's smartphone. Users will discover this page via the QR codes displayed at participating restrooms.

At step 2606, the user comes to a Sign-up Page (not shown) at which a restroom owner may register with a user name and password. Once registered, he is redirected at step 2608 to an Authentication/Login page (not shown). At this page, a user may login to the system using his unique username and password. Once authenticated, a user will arrive at step 2610 at the Web App Home page (not shown). From this Web App Home page, restroom owners can register new restrooms (using QR codes provided by their distributor or service company), or claim a restroom that is already listed in the system (allowing them to print a unique QR code directly from the application for each claimed restroom), as shown at step 2612.

As shown at step 2614, restroom owners can also view a list of their restrooms, allowing them to view notifications and mark those issues which have been fixed, shown at step 616. They can also edit their existing listings or print new QR codes to replace those that were lost, damaged, vandalized, as shown at step 2618 and 2620.

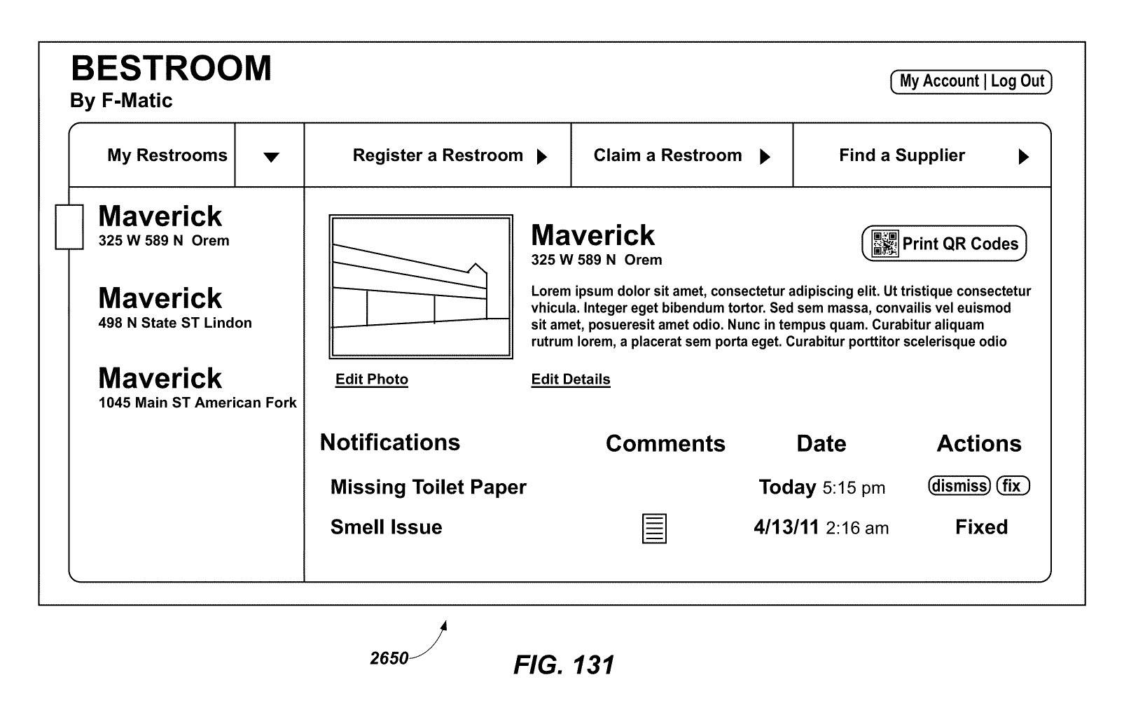

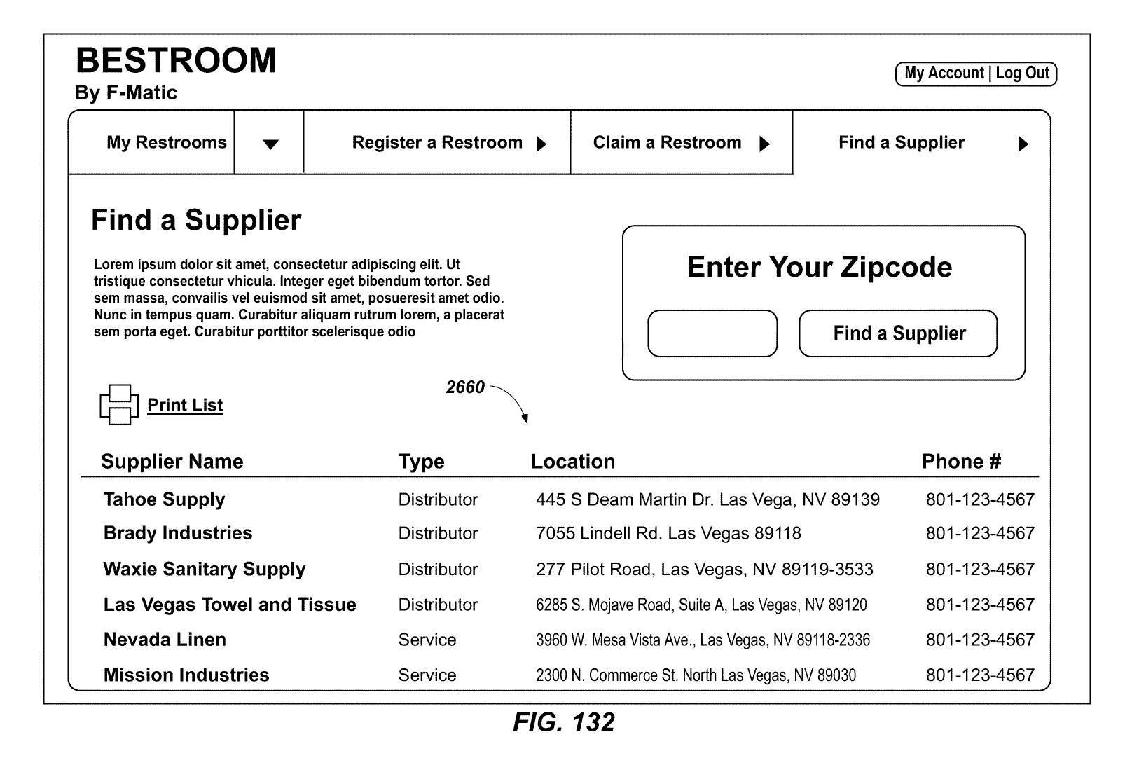

Referring to FIG. 131, a sample Restroom List screen page is shown, providing information 2650 regarding the status and supplies needed for a specific location of a restroom. In the event that the restroom owner needs to order supplies, a Supplier List screen can be accessed, as shown in FIG. 132, with information 2660 regarding available suppliers for a needed product. This screen may list nearby suppliers based upon a user's known location or an entered zip code. Suppliers may be listed in order of distance or other criteria, although it is envisioned that advertisers and higher-tier customers may receive promoted placement on these lists.

The embodiments of the present systems described above may be applied in a variety of different uses, including without limitation, in connection with the cleaning and maintenance of hotel and motel rooms, restaurant dining and kitchen areas and other public and private rooms and areas.

### Other Examples of Uses for the Present Systems.

In addition to restroom maintenance, the following examples, although not all inclusive, are indicative of some of the ways the Quick Request system can be used to enable better service, better communication, automatic dispatching and tracking of issues between employees, customers, guests, patrons, or the public and a company's employees that can take care of issues that are presented.

Hotels:

In a hotel the system may be used by a guest to report problems with his room in terms of maintenance and cleanliness. It may be used by a guest to order room service, more towels, bottled water any number of other products or services. A guest may use it to reserve services in the hotel like a spa treatment or a golf time. He may also use it to provide the hotel with feedback concerning his stay. The hotel staff may use the service to track employee performance by having an employee check in as he enters each room and then report with the service what he did while he was there and then check out creating a time log of work done.

Universities:

In universities, colleges and schools the system may be used to enable students and teachers to report maintenance issues, report custodial needs, report informational technology needs and or security threats. It may be used in both the classroom and the public restrooms.

Security Companies:

In a security company the security guards may scan plaques along the routes that enable the company to get a real time report of where all its security guards are, what the status of each location is and also to validate through GPS that the security guard is performing his or her duty as prescribed.

Theaters:

In theaters a patron of the theater may report problems concerning the restrooms, his theater seat, sound quality, picture quality, cleanliness of the floor as well as rate the individual movies, rate the theater and rate the concession. The system even enables a patron to vote on or suggest new concession items to be added.

Building Contractors:

A building contractor may use the Quick Request system to track subcontractors to know who is on the job at what home or building in real time. He may also have the subcontractors report their daily progress keeping the contractor informed of the progress. The present system saves the contractor from driving around to see if everyone showed up and then calling them if they did not show up. He may use the system to report security issues or vandalism and track any patterns that may come from such data. He may use the system to alert the next crew to work on the site that it is ready after the last crew finished their stage of the project.

Arenas, Stadiums and Sporting Event Centers:

With a QR code at every seat, the stadium or center may enable every sports fan with the ability to order food and beverages delivered directly to his seat. He may report security concerns discreetly and provide feedback on the facilities and restrooms. He may also answer trivia questions about his sports team.

Textile Rental Companies:

With a QR code at every customer location of a textile rental company, the company may track the route progress of its drivers and have them report on what was delivered at each location. It may also enable a restaurant owner or quick lube shop owner with the ability to report problems concerning his uniforms, rugs and linens as well as order more products and services as needed without calling the textile rental company to explain his needs. He may also use the present system for surveys to track the sentiment of the companies he serves.

Shipping Companies:

With a QR code on each package, smaller shipping companies may use the Quick Request system to track the progress of each package and its status as it moves from pickup, to transit, to delivery. Any driver or worker in the process that has a smartphone may report on the status of the package at any step in the process without an expensive scanner and tracking system that the larger companies use.

These are just a few examples of uses of the system of the present invention. Since the Quick Request system is a communication service, it does not require the sender to know who he is reporting a problem to, making a request a service or product of or providing feedback to. He may just report his issue and be done. Because the system is so flexible and customizable, the number of industries and usages are vast and varied.

As can be seen from the foregoing description the present invention includes but is not limited to the following features. The present systems provide means to (1) report problems about locations, rooms, equipment, machinery, grounds, properties, products and or people in substantial detail with limited input, (2) make requests for services and products, (3) provide feedback, complete surveys, review, rate and comment on facilities, service, equipment, machinery, people and products, (4) track employee performance, time on any specific task or at any location doing any number of jobs with substantial detail and limited input.

Using electronically detectable codes, such as QR codes, the present system provides means to (1) identify locations, public spaces, products, and services among multiple locations in large and/or multi-level facilities, (2) couple the codes with GPS location data to ensure that a user is at the claimed location, when reporting a problem, making a request, providing feedback, or completing a job report.

The present system provides means for persons, such as customers, guests, and patrons, communicate their concerns, needs and feedback without tedious manual routing to find an individual that needs to receive the information. The present system enables anyone with a smart mobile phone to report and log issues as job tickets and have the job automatically dispatched to a worker. The present system provides for logging a service personnel's time to provide a supervisor with remote monitoring of services performed, elapsed time, and accurate time accounting for employees. The present system enables ordering of products or services via a smart mobile phone application based on real-time needs and feedback received from end users.

It will be understood that the invention may be embodied in other specific forms by one of ordinary skill in the art without departing from the spirit, characteristics or coverage of the present invention. The present example and embodiment are to be considered to be illustrative and not restrictive, and the invention is not intended to be limited to the details of the described embodiments. Rather, the invention is defined by the claims, and as broadly as the prior art will permit.

What is claimed:

1. A computer program process for interaction between an online computer program and a mobile electronic device to carry out a task set up by the online computer program, comprising:
positioning a unit having a detectable code thereon at a location remote from the computer program, wherein the detectable code is indicative of the location and/or characteristics of the location;
sensing the detectable code using the mobile electronic device;
providing information from the detectable code to the online computer program using the mobile electronic device;
enabling the electronic device with application software to communicate with the online computer program;
providing additional data regarding the location to the computer program using the mobile electronic device; and
carrying out a task using the online computer program in response to the detectable code and the additional data.

2. The process of claim 1, wherein the task is to report a problem at the location.

3. The process of claim 1, wherein the task is to request services and/or products.

4. The process of claim 1, wherein the task is to provide feedback on performance, employees, facilities, equipment, machinery, products and/or services associated with the location.

5. The process of claim 1, wherein the task is to provide the presence and/or status of a person associated with the location.

6. The process of claim 5, further comprising using a separate location device to confirm the location of the person.

7. The process of claim 1, wherein the task is to control the action of a device or system associated with the location.

8. The process of claim 6, wherein the task is to activate or de-activate a door.

9. The process of claim 1, further including providing electronic feedback to the mobile device confirming that the task had been performed.

10. The process of claim 1, wherein the application software is made available by the online computer program for the mobile electronic device to use while communicating with the online computer program.

11. The process of claim 1, wherein the application software is downloaded from the online computer program to the mobile device.

12. The process of claim 1, wherein the detectable code is a QR code.

13. The process of claim 1, wherein the unit is a plaque, sticker or printing having the detectable code thereon.

14. A process for remotely tracking, reporting, tasking and providing information regarding a location, using a mobile electronic device interacting with an online computer program, comprising:
positioning a unit having a detectable code thereon at the location, wherein the detectable code is indicative of the location and/or other characteristics of the location;
sensing the detectable code using the electronic device;
providing information from the detectable code to the online computer program using the mobile electronic device;
enabling the electronic device with application software to communicate with the online computer program;
providing additional data regarding the location to the computer program using the mobile electronic device; and
carrying out a task using the online computer program in response to the information from the detectable code and the additional data.

15. The process of claim 14, wherein the location is a restroom and the task is to report on the status of the restroom, and/or to order supplies or service for changing the status of the restroom.

16. The process of claim 14, wherein the location is a hotel room and the task is to report on the status of the hotel room and/or to order supplies or service for changing the status of the hotel room.

17. The process of claim 14, wherein the location is a hotel room and the task is to activate or de-activate the door to the hotel room.

18. The process of claim 14, wherein the location is a facility or equipment and the task is to report on the status of the facility or equipment and/or to order supplies or service for changing the status of the facility or equipment.

19. The process of claim 14, wherein the location is a restaurant or hotel room, and the task is to order food and/or to report on the status of service in the restaurant or hotel room.

20. The process of claim 14, wherein the location is a theater, stadium or arena and the task is to order tickets and/or concessions and/or to report on the status of service in the theater, stadium or arena.

21. A system for interaction with an online computer program to carry out a task set up by the online computer program, comprising:
a unit having a detectable code thereon at a location remote from the computer program, wherein the detectable code is indicative of the location and/or characteristics of the location;
a mobile electronic device capable of sensing the detectable code and providing information from the detectable code to the online computer program;
application software provided to the mobile electronic device by the online computer program, to enable the mobile electronic device to provide additional data regarding the location to the computer program using the mobile electronic device; whereby the online computer program conducts a task in response to the detectable code and the additional data.

22. The system of claim 21, wherein the task is to report a problem at the location.

23. The system of claim 21, wherein the task is to request services and/or products.

24. The system of claim 21, wherein the task is to provide feedback on performance, facilities, products and/or services associated with the location.

25. The system of claim 21, wherein the task is to provide the presence and/or status of a person associated with the location or the status of any equipment or machinery at a location.

26. The system of claim 25, further comprising using a separate location device to confirm the location of the person.

27. The system of claim 21, wherein the task is to control the action of a device or system associated with the location.

28. The system of claim 26, wherein the task is to activate or de-activate a door or other electronic device.

29. The system of claim 21, further including providing electronic feedback to the mobile device confirming that the task had been performed.

30. The system of claim 21, wherein the application software is made available by the online computer program for the mobile electronic device to use while communicating with the online computer program.

31. The system of claim 21, wherein the application software is downloaded from the online computer program to the mobile device.

32. The system of claim 21, wherein the detectable code is a QR code.

33. The system of claim 21, wherein the unit is a plaque, sticker or printing having the detectable code thereon.

34. A system for remotely tracking, reporting, tasking and providing information regarding a location, using an online computer program, comprising:
a unit having a detectable code thereon at a location remote from the computer program, wherein the detectable code is indicative of the location and/or characteristics of the location;
a mobile electronic device capable of sensing the detectable code and providing information from the detectable code to the online computer program;
application software provided to the mobile electronic device by the online computer program, to enable the mobile electronic device to provide additional data regarding the location to the computer program using the mobile electronic device; whereby the online computer program conducts a task in response to the detectable code and the additional data.

35. The system of claim 34, wherein the location is a restroom and the task is to report on the status of the restroom, and/or to order supplies or service for changing the status of the restroom.

36. The system of claim 34, wherein the location is a hotel room and the task is to report on the status of the hotel room and/or to order supplies or service for changing the status of the hotel room.

37. The system of claim 34, wherein the location is a hotel room and the task is to activate or de-activate the door to the hotel room.

38. The system of claim 34, wherein the location is a facility or equipment and the task is to report on the status of the facility or equipment and/or to order supplies or service for changing the status of the facility or equipment.

39. The system of claim 34, wherein the location is a restaurant or hotel room, and the task is to order food and/or to report on the status of service in the restaurant or hotel room.

40. The system of claim 34, wherein the location is a theater, stadium or arena and the task is to order tickets and/or concessions and/or to report on the status of service in the theater, stadium or arena.
